(19) United States
(12) Patent Application Publication
(10) Pub. No.: US 2026/0072232 A1
(43) Pub. Date: Mar. 12, 2026

(54) OPTICAL LENS, CAMERA MODULE AND ELECTRONIC DEVICE

(71) Applicant: LARGAN INDUSTRIAL OPTICS CO., LTD., Taichung City (TW)

(72) Inventors: Hsuan-Chin HUANG, Taichung City (TW); Hong Rong KUO, Taichung City (TW); Hsiu-Yi HSIAO, Taichung City (TW); Yu Chen LAI, Taichung City (TW)

(73) Assignee: LARGAN INDUSTRIAL OPTICS CO., LTD., Taichung City (TW)

(21) Appl. No.: 19/251,180

(22) Filed: Jun. 26, 2025

Related U.S. Application Data
(60) Provisional application No. 63/693,120, filed on Sep. 10, 2024.

(51) Int. Cl. G02B 7/02

(52) U.S. Cl. CPC G02B 7/021

(57) ABSTRACT

An optical lens includes a lens barrel, a lens element, a spacer element and a retaining element. The spacer element has a near-axis side surface, a far-axis side surface, and first and second surfaces arranged opposite to each other. The near-axis side surface is connected to the first and second surfaces on a side closest to an optical axis and tapers toward the optical axis, forming a light-passing hole. The far-axis side surface is connected to the first and second surfaces on a side farthest from the optical axis. The retaining element is fixed to the lens barrel. The spacer element is between the lens element and the retaining element. The lens element has a first region surrounding the optical axis and supported on the first surface. The retaining element has a second region surrounding the optical axis and supported on the second surface.

### RELATED APPLICATIONS

This application claims priority to U.S. Provisional Application 63/693,120, filed on Sep. 10, 2024, which is incorporated by reference herein in its entirety.

### BACKGROUND

### Technical Field

The present disclosure relates to an optical lens, a camera module and an electronic device, more particularly to an optical lens and a camera module applicable to an electronic device.

### Description of Related Art

With the development of semiconductor manufacturing technology, the performance of image sensors has been improved, and the pixel size thereof has been scaled down. Therefore, featuring high image quality becomes one of the indispensable features of an optical lens nowadays. Furthermore, due to the rapid changes in technology, smartphone devices equipped with optical lenses are trending towards multi-functionality for various applications, and therefore the functionality requirements for the optical lenses have been increasing.

With the increasing demands for photography, optical lenses are required to adapt to increasingly harsh environments. When the lens elements within an optical lens deform due to environmental changes, the resulting stress can impact optical quality. Therefore, improving the structure of internal components in optical lenses to minimize the effects of environmental variations on image quality has become a crucial issue in the field, aiming to meet the high-performance requirements of modern electronic devices.

### SUMMARY

According to one aspect of the present disclosure, an optical lens has an optical axis and includes a lens barrel, a lens element, a spacer element and a retaining element. The optical axis passes through the lens barrel. The lens element is arranged along the optical axis and disposed in the lens barrel, and the lens element has a first region surrounding the optical axis. The spacer element is arranged adjacent to the lens element and surrounds the optical axis, and the spacer element has a first surface, a second surface, a near-axis side surface and a far-axis side surface. The first region of the lens element is supported on the first surface in a direction parallel to the optical axis. The second surface is disposed opposite to the first surface. The near-axis side surface is connected to the first surface on a side closest to the optical axis and to the second surface on a side closest to the optical axis, and the near-axis side surface surrounds the optical axis and gradually tapers toward the optical axis, forming a light-passing hole. The far-axis side surface is connected to the first surface on a side farthest from the optical axis and to the second surface on a side farthest from the optical axis. The retaining element is fixedly arranged with the lens barrel to maintain a relative fixed position between the lens element and the lens barrel along the optical axis. The spacer element is disposed between the lens element and the retaining element. The retaining element has a second region surrounding the optical axis, and the second region is supported on the second surface in a direction parallel to the optical axis. In addition, the first region and the second region do not overlap in a direction parallel to the optical axis.

According to another aspect of the present disclosure, an optical lens has an optical axis and includes a lens barrel, a lens element, a spacer element and a retaining element. The optical axis passes through the lens barrel, and the lens barrel has a first annular surface surrounding the optical axis. The lens element is arranged along the optical axis and disposed on the first annular surface of the lens barrel, and the lens element has a first region surrounding the optical axis. The spacer element is arranged adjacent to the lens element and surrounds the optical axis, and the spacer element has a first surface, a second surface, a near-axis side surface and a far-axis side surface. The first region of the lens element is supported on the first surface in a direction parallel to the optical axis. The second surface is disposed opposite to the first surface. The near-axis side surface is connected to the first surface on a side closest to the optical axis and to the second surface on a side closest to the optical axis, and the near-axis side surface surrounds the optical axis and gradually tapers toward the optical axis, forming a light-passing hole. The far-axis side surface is connected to the first surface on a side farthest from the optical axis and to the second surface on a side farthest from the optical axis. The retaining element is fixedly arranged with the lens barrel to maintain a relative fixed position between the lens element and the lens barrel along the optical axis. The spacer element is disposed between the lens element and the retaining element. The retaining element has a second annular surface and a second region both surrounding the optical axis, and the second region is supported on the second surface in a direction parallel to the optical axis. In addition, a gap is formed between the far-axis side surface and at least one of the first annular surface and the second annular surface, and the gap extends from the far-axis side surface toward the optical axis along at least one of the first surface and the second surface. Moreover, the first annular surface and/or the second annular surface, which form the gap with the far-axis side surface, face the far-axis side surface. Moreover, the gap overlaps with one of the first region and the second region in a direction parallel to the optical axis.

According to another aspect of the present disclosure, a camera module includes the aforementioned optical lens and an image sensor disposed on an image surface of the optical lens.

According to another aspect of the present disclosure, an electronic device includes the aforementioned camera module.

### BRIEF DESCRIPTION OF THE DRAWINGS

The disclosure can be better understood by reading the following detailed description of the embodiments, with reference made to the accompanying drawings as follows:

FIG. 1 is a sectional view of an optical lens according to the 1st embodiment of the present disclosure;

FIG. 2 is an enlarged view of region EL2 in FIG. 1;

FIG. 3 is an exploded view of the optical lens in FIG. 1;

FIG. 4 is a cross-sectional view of the optical lens in FIG. 1;

FIG. 5 is an enlarged view of region EL5 in FIG. 4;

FIG. 6 is a plan view of a spacer element of the optical lens according to the 1st embodiment of the present disclosure;

FIG. 7 is a sectional view of an optical lens according to the 2nd embodiment of the present disclosure;

FIG. 8 is an enlarged view of region EL8 in FIG. 7;

FIG. 9 is an exploded view of the optical lens in FIG. 7;

FIG. 10 is a cross-sectional view of the optical lens in FIG. 7;

FIG. 11 is an enlarged view of region EL11 in FIG. 10;

FIG. 12 is a plan view of a spacer element of the optical lens according to the 2nd embodiment of the present disclosure;

FIG. 13 is a sectional view of an optical lens according to the 3rd embodiment of the present disclosure;

FIG. 14 is an enlarged view of region EL14 in FIG. 13;

FIG. 15 is an exploded view of the optical lens in FIG. 13;

FIG. 16 is a cross-sectional view of the optical lens in FIG. 13;

FIG. 17 is an enlarged view of region EL17 in FIG. 16;

FIG. 18 is a plan view of a spacer element of the optical lens according to the 3rd embodiment of the present disclosure;

FIG. 19 is a sectional view of an optical lens according to the 4th embodiment of the present disclosure;

FIG. 20 is an enlarged view of region EL20 in FIG. 19;

FIG. 21 is an exploded view of the optical lens in FIG. 19;

FIG. 22 is a cross-sectional view of the optical lens in FIG. 19;

FIG. 23 is an enlarged view of region EL23 in FIG. 22;

FIG. 24 is a plan view of a spacer element of the optical lens according to the 4th embodiment of the present disclosure;

FIG. 25 is a plan view of a spacer element of an optical lens according to one configuration of the present disclosure;

FIG. 26 is a plan view of a spacer element of an optical lens according to another configuration of the present disclosure;

FIG. 27 is a perspective view of an electronic device according to the 5th embodiment of the present disclosure;

FIG. 28 is another perspective view of the electronic device in FIG. 27;

FIG. 29 is an illustration of an image captured by an ultra-wide-angle camera module;

FIG. 30 is an illustration of an image captured by a high pixel camera module;

FIG. 31 is an illustration of an image captured by a telephoto camera module;

FIG. 32 is a perspective view of an electronic device according to the 6th embodiment of the present disclosure;

FIG. 33 is a perspective view of an electronic device according to the 7th embodiment of the present disclosure;

FIG. 34 is a side view of the electronic device in FIG. 33;

FIG. 35 is a top view of the electronic device in FIG. 33; and

FIG. 36 is a perspective view of an electronic device according to the 8th embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides an optical lens. The optical lens includes a lens barrel, a lens element, a spacer element and a retaining element. The optical lens has an optical axis, and the optical axis passes through the lens barrel. The lens element is arranged along the optical axis and disposed in the lens barrel, and the lens element has a first region surrounding the optical axis.

The spacer element is arranged adjacent to the lens element and surrounds the optical axis, and the spacer element has a first surface, a second surface, a near-axis side surface and a far-axis side surface. The second surface is disposed opposite to the first surface, and the first region of the lens element is supported on the first surface in a direction parallel to the optical axis. The near-axis side surface is connected to the first surface on a side closest to the optical axis and to the second surface on a side closest to the optical axis, and the near-axis side surface surrounds the optical axis and gradually tapers toward the optical axis, forming a light-passing hole. The far-axis side surface is connected to the first surface on a side farthest from the optical axis and to the second surface on a side farthest from the optical axis. Additionally, the spacer element can have a light-blocking function to prevent glare.

The retaining element is fixedly arranged with the lens barrel to maintain a relative fixed position between the lens element and the lens barrel along the optical axis. Specifically, the retaining element is correspondingly arranged with the lens element to maintain the position of the lens element within the lens barrel, preventing the lens element from tilting or detaching easily and ensuring the stability of optical image quality. Moreover, the retaining element can be secured to the lens barrel through means such as threading, adhesive bonding or mechanical clips. Alternatively, the retaining element can be integrally formed with the lens barrel. However, the present disclosure is not limited thereto.

The retaining element has a second region surrounding the optical axis, the spacer element is disposed between the lens element and the retaining element, and the second region of the retaining element is supported on the second surface of the spacer element in a direction parallel to the optical axis.

According to the optical lens as disclosed in the present disclosure, the corresponding arrangement of the spacer element, the lens barrel, the lens element, and the retaining element allows for a controlled change in the distance between the lens element and the retaining element when the lens element deforms due to environmental changes so as to prevent stress from adversely affecting optical quality.

In one configuration, the first region of the lens element and the second region of the retaining element may not overlap in a direction parallel to the optical axis. Therefore, by spacing the lens element and the retaining element apart with the spacer element, and ensuring that the first region and the second region do not overlap in a direction parallel to the optical axis, the distance between the lens element and the retaining element can be controllably adjusted when the lens element deforms due to environmental changes, thereby preventing stress from adversely affecting optical quality.

In one configuration, a gap can be formed between the far-axis side surface of the spacer element and at least one of the lens barrel and the retaining element, and the gap can extend from the far-axis side surface toward the optical axis along at least one of the first surface and the second surface. Therefore, it is favorable for the gap to provide a margin for the spacer element to deform, preventing buckling or displacement during deformation, thereby maintaining structural stability. Specifically, the lens barrel can have a first annular surface surrounding the optical axis, and the lens element can be arranged along the optical axis and disposed on the first annular surface of the lens barrel. Furthermore, the retaining element can further have a second annular surface surrounding the optical axis. Moreover, a gap can be formed between the far-axis side surface of the spacer element and at least one of the first annular surface and the second annular surface, and the gap can extend from the far-axis side surface toward the optical axis along at least one of the first surface and the second surface. Moreover, the first annular surface and/or the second annular surface, which form the gap with the far-axis side surface, can face the far-axis side surface. Therefore, it is favorable for the gap to provide space for the spacer element to deform in a direction parallel to the optical axis and/or in a direction perpendicular to the optical axis; additionally, since the gap is formed at the far-axis side surface, it is favorable for preventing lateral forces perpendicular to the optical axis from acting on the spacer element during deformation, thereby preventing displacement that could adversely affect optical quality. The first annular surface of the lens barrel can refer to an inner surface of the lens barrel, and the inner surface of the lens barrel can accommodate the placement of the lens element and other optical components, such as spacer rings, retaining rings, and light-blocking elements. The second annular surface of the retaining element can refer to an inner surface of the retaining element, and the inner surface of the retaining element can, for example, abut an outer surface of the lens barrel, be assembled with the lens barrel, and/or abut the spacer element.

The gap can overlap with one of the first region and the second region in a direction parallel to the optical axis. Therefore, it is favorable for the specific distance between the lens element and the retaining element to change with environmental variations, preventing stress from adversely affecting the optical quality of the lens element, thereby enhancing the environmental adaptability of the optical lens.

The spacer element and at least one of the lens barrel and the retaining element can have a clearance fit with each other in a direction perpendicular to the optical axis. Therefore, during mechanical assembly, a deformation margin for the spacer element can be maintained to prevent interference with other components during deformation. The clearance fit can also be referred to as a loose fit. It should be noted that the first region of the lens element and the second region of the retaining element are mechanically arranged in a substantially coaxial manner. However, since the spacer element is assembled with the lens barrel or the retaining element using a clearance fit, regions of the first region and the second region surrounding the optical axis may be approximately coaxial.

The retaining element can include a retaining portion extending in a direction toward the optical axis, and the retaining portion has the second region.

The retaining element can further include a barb structure arranged spaced apart from the retaining portion, and the barb structure is located closer to the optical axis than the far-axis side surface of the spacer element. Moreover, the spacer element can be disposed between the barb structure and the retaining portion. Therefore, the spacer element is pre-assembled using the barb structure to prevent the spacer element from detaching from the retaining element, thereby improving the assembly process.

The barb structure can face the lens element and be arranged spaced apart from the lens element, and the barb structure can be located farther from the optical axis than the lens element. Therefore, a space formed between the lens element and the barb structure provides a deformation margin for the lens element and/or the spacer element, and assembly interference between components can be reduced after deformation of the lens element and/or the spacer element. Moreover, the gap can further include a spacing between the barb structure and the lens element. For example, the gap formed between the far-axis side surface of the spacer element and the lens barrel and/or the retaining element can extend to the space between the barb structure and the lens element.

The lens barrel, the spacer element and the retaining element each can be made of, for example, plastic material or metal material, but the present disclosure is not limited thereto. Moreover, in one configuration where the spacer element is made of plastic material, the spacer element can elastically deform when the lens element deforms, adaptively reducing stress on the lens element and maintaining the position of the lens element to maintain optical quality. Moreover, in one configuration where the retaining element is made of metal material, the retaining portion can have sufficient rigidity to prevent the lens element from detaching. The metal material can be, for example, aluminum or brass, but the present disclosure is not limited thereto. Moreover, assembling a metal retaining element with a plastic lens barrel can enhance the axial deformation resistance of the plastic lens barrel, thereby improving the impact resistance of the optical lens.

According to the present disclosure, the optical lens can include a lens group, the lens group includes the lens element as described above, and the lens group can include at least one plastic lens element and at least one glass lens element. Therefore, the optical lens includes both plastic lens element(s) and glass lens element(s), enhancing optical quality and reducing the impact of environmental factors on the optical lens. Moreover, the lens element can be made of plastic material. Therefore, it is favorable for correcting edge imaging, thereby improving overall optical quality. Moreover, the lens group is arranged along the optical axis and disposed on the first annular surface of the lens barrel; that is, all lens elements of the lens group can be sequentially arranged along the optical axis, and these lens elements can be all disposed on the first annular surface of the lens barrel.

According to the present disclosure, the optical lens can further include a damper disposed in the gap. Therefore, it is favorable for providing a buffering function and further enhancing the airtightness of the optical lens. Additionally, disposing the damper in the gap can also reduce the chance of the spacer element becoming eccentric.

According to the present disclosure, the optical lens can further include a light-blocking element surrounding the optical axis. Moreover, the light-blocking element can be disposed between the lens element and the spacer element, or between the spacer element and the retaining element. Therefore, it is favorable for reducing the risk of light leakage when the spacer element deforms, thereby ensuring optical quality.

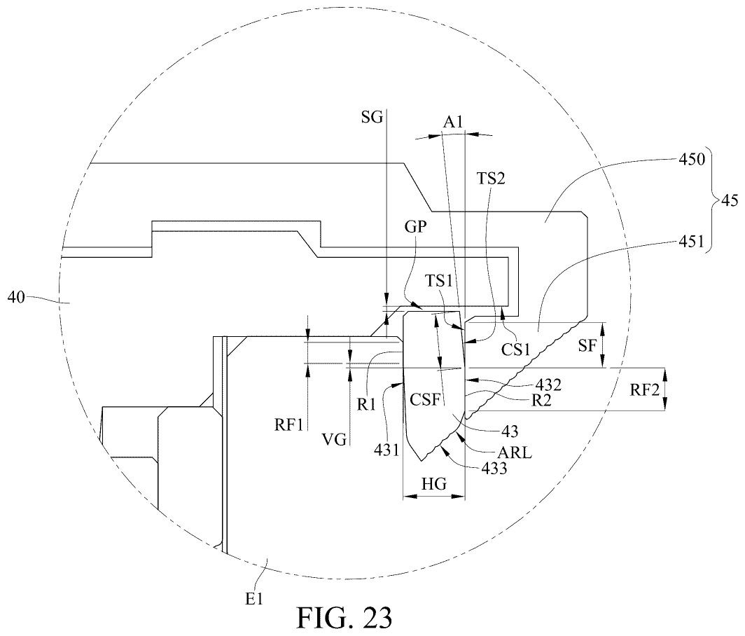

The near-axis side surface of the spacer element can have an anti-reflective surface, and a reflectance of the anti-reflective surface is lower than a reflectance of the far-axis side surface. Therefore, it is favorable for preventing light from reflecting on the near-axis side surface, thereby ensuring optical quality. Moreover, the anti-reflective surface can reduce reflection through special concave-convex structures, V-groove structures, anti-reflective coatings, or nano-coatings, but the present disclosure is not limited thereto. For example, as shown in FIG. 23, the anti-reflective surface ARL of the near-axis side surface 433 features a concave-convex structure.

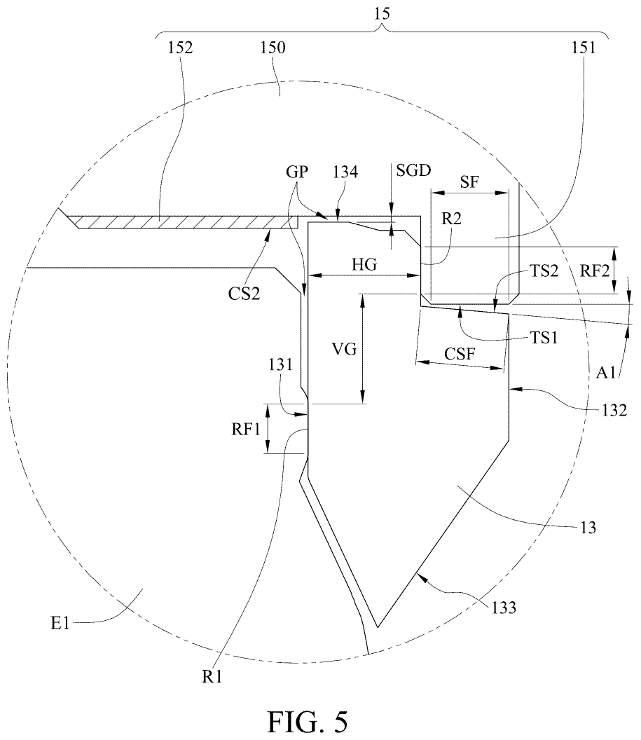

When a distance between the first region of the lens element and the second region of the retaining element in a direction perpendicular to the optical axis is VG, the following condition can be satisfied: 0.01 mm≤VG≤1.2 mm. Therefore, within a specific range of distance, the displacement or deformation of the spacer element can be controlled. Please refer to FIG. 5, which shows a schematic view of VG according to the 1st embodiment of the present disclosure.

When the distance between the first region and the second region in the direction perpendicular to the optical axis is VG, and a distance between the first region and the second region in a direction parallel to the optical axis is HG, the following condition can be satisfied: 0.03≤VG/HG≤3.1. Therefore, within a specific range of distance, the displacement or deformation of the spacer element can be controlled. Please refer to FIG. 5, which shows a schematic view of HG and VG according to the 1st embodiment of the present disclosure.

A cross-section parallel to the optical axis and passing through the optical axis is defined. In the cross-section, when a length of the first region in a direction perpendicular to the optical axis is RF1, and a length of the second region in a direction perpendicular to the optical axis is RF2, the following condition can be satisfied: 0.1≤RF1/RF2≤5.1. Therefore, it is favorable for the yield rate of mechanical assembly to be improved at a specific length ratio. Moreover, the following condition can also be satisfied: 0.2≤RF1/RF2≤2.5. Please refer to FIG. 5, which shows a schematic view of RF1 and RF2 according to the 1st embodiment of the present disclosure.

The retaining portion can further have a stop surface, the spacer element can further have a counterpart stop surface disposed opposite to the stop surface, and a distance between the counterpart stop surface and the stop surface gradually increases in a direction away from the second region. Moreover, the stop surface and the counterpart stop surface form an angle A1 in the cross-section parallel to the optical axis and passing through the optical axis, and the following condition can be satisfied: A1≤20 degrees. Therefore, it is favorable for preventing excessive deformation of the spacer element, thereby extending the lifespan of the optical lens. Please refer to FIG. 5, which shows a schematic view of A1 according to the 1st embodiment of the present disclosure.

When a length of the stop surface in the cross-section is SF, and a length of the counterpart stop surface in the cross-section is CSF, the following condition can be satisfied: 0.4≤SF/CSF≤2.5. Therefore, it is favorable for providing sufficient support after the spacer element deforms. Please refer to FIG. 5, which shows a schematic view of SF and CSF according to the 1st embodiment of the present disclosure.

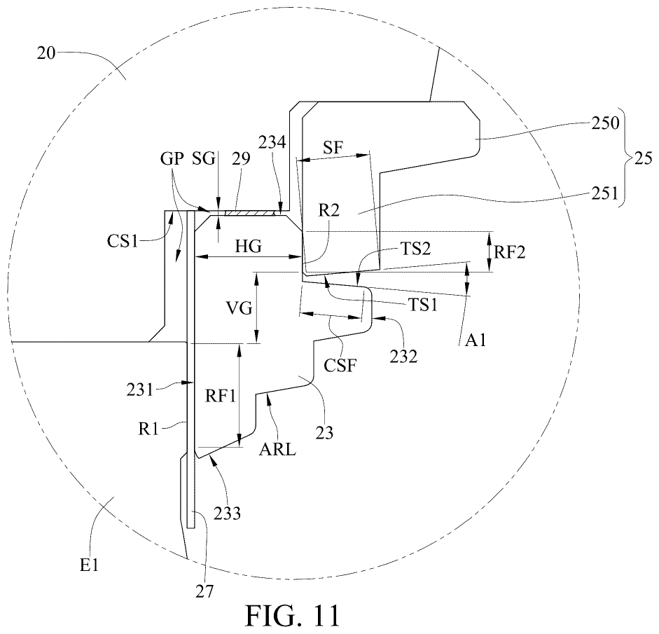

In one configuration where the far-axis side surface of the spacer element faces the lens barrel, when a distance between the far-axis side surface and the lens barrel in a direction perpendicular to the optical axis is SG, the following condition can be satisfied: 0.007 mm≤SG≤0.06 mm. Therefore, a consistent level of optical imaging quality can be maintained within a specific spacing range. Please refer to FIG. 11, which shows a schematic view of SG according to the 2nd embodiment of the present disclosure.

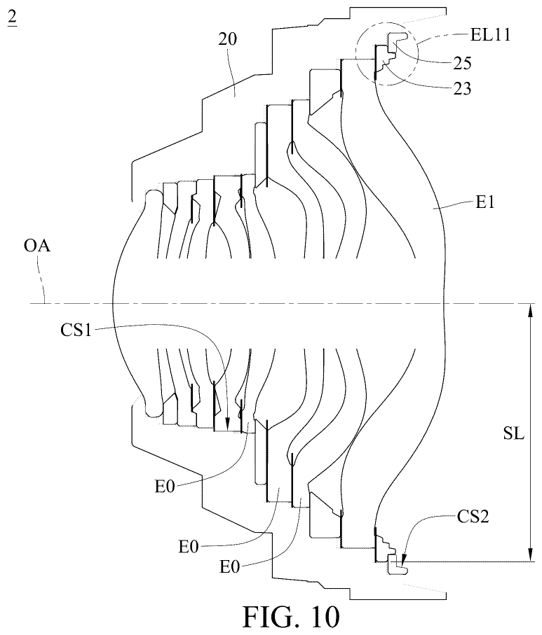

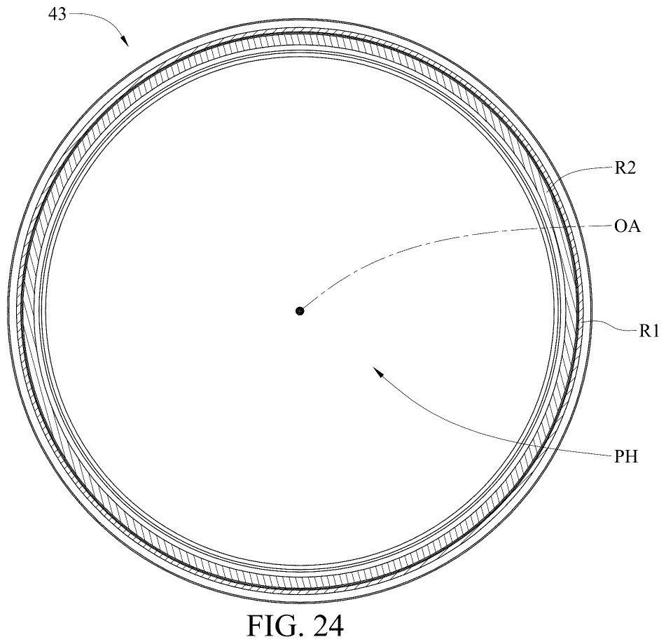

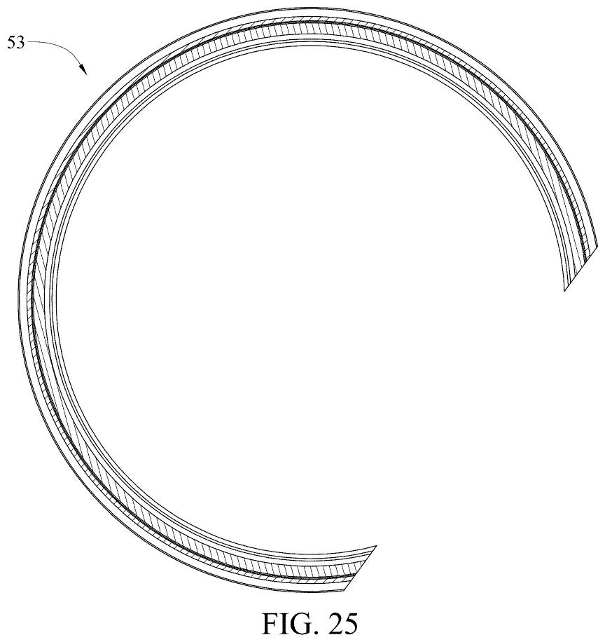

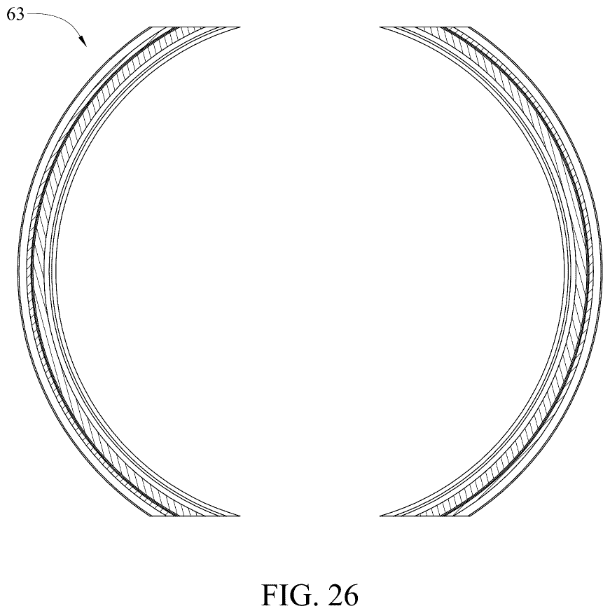

When a maximum distance between the spacer element and a center of the lens element is SL, and the distance between the far-axis side surface and the lens barrel in the direction perpendicular to the optical axis is SG, the following condition can be satisfied: 0.9901≤SL/(SL+SG)≤0.9999. Therefore, using a clearance fit for mechanical assembly can maintain the gap size within a specific range, ensuring the overall stability of the mechanism. Please refer to FIG. 10 and FIG. 11, which respectively show schematic views of SL and SG according to the 2nd embodiment of the present disclosure. Moreover, the spacer element can be an annular element or an arc-shaped element, but the present disclosure is not limited thereto. For example, please refer to FIG. 24 to FIG. 26, which respectively show plan views of spacer elements of optical lenses according to different configurations of the present disclosure. As shown in FIG. 24, the spacer element 43 is an annular element. As shown in FIG. 25, the spacer element 53 is an arc-shaped element with a single cut edge, and the shape of the spacer element 53 may be designed, for example, to correspond to a lens element with a single cut edge, but the present disclosure is not limited thereto. As shown in FIG. 26, the spacer element 63 is an arc-shaped element with a pair of cut edges, and the shape of the spacer element 63 may be designed, for example, to correspond to a lens element with a pair of cut edges, but the present disclosure is not limited thereto. The maximum distance between the spacer element and the center of the lens element can be regarded as an outer diameter of the annular spacer element or the arc-shaped spacer element.

In another configuration where the far-axis side surface of the spacer element faces the retaining element, when a distance between the far-axis side surface and the retaining element in a direction perpendicular to the optical axis is SGD, the following condition can be satisfied: 0.007 mm≤SGD≤0.06 mm. Therefore, consistent level of optical imaging quality can be maintained within a specific spacing range. Please refer to FIG. 5, which shows a schematic view of SGD according to the 1st embodiment of the present disclosure.

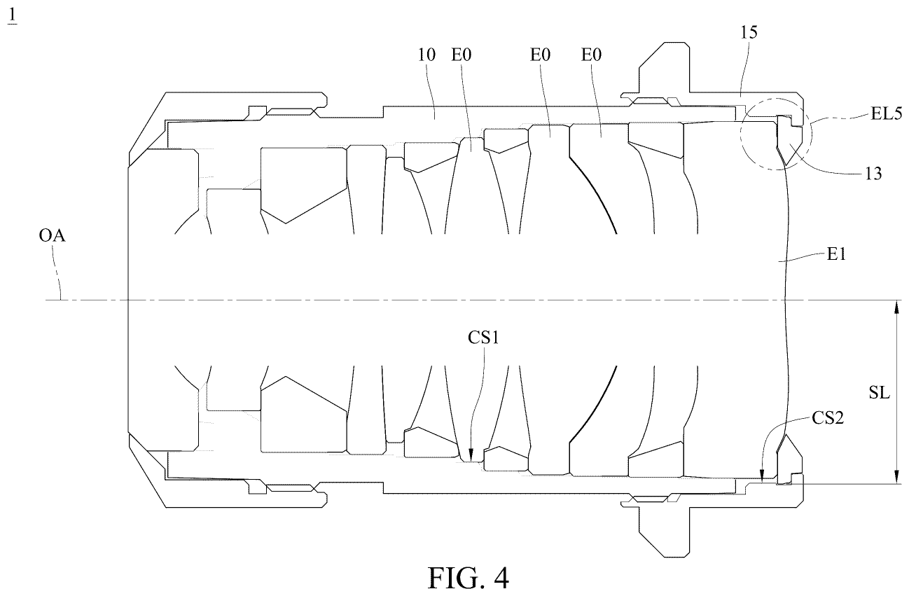

When the maximum distance between the spacer element and the center of the lens element is SL, and the distance between the far-axis side surface and the retaining element in the direction perpendicular to the optical axis is SGD, the following condition can be satisfied: 0.9901≤SL/(SL+SGD)≤0.9999. Therefore, using a clearance fit for mechanical assembly can maintain the gap size within a specific range, ensuring the overall stability of the mechanism. Please refer to FIG. 4 and FIG. 5, which respectively show schematic views of SL and SGD according to the 1st embodiment of the present disclosure. Moreover, the spacer element can be an annular element or an arc-shaped element, but the present disclosure is not limited thereto. The spacer element may, for example, be designed as an arc-shaped element with cut edges corresponding to a lens element with cut edges, but the present disclosure is not limited thereto. The maximum distance between the spacer element and the center of the lens element can be regarded as the outer diameter of the annular spacer element or the arc-shaped spacer element.

According to the present disclosure, a camera module is provided. The camera module includes an image sensor and the aforementioned optical lens, and the image sensor is disposed on an image surface of the optical lens.

According to the present disclosure, an electronic device is provided. The electronic device includes the aforementioned camera module.

According to the present disclosure, the aforementioned features and conditions can be utilized in numerous combinations so as to achieve corresponding effects.

According to the above description of the present disclosure, the following specific embodiments are provided for further explanation.

### 1st Embodiment

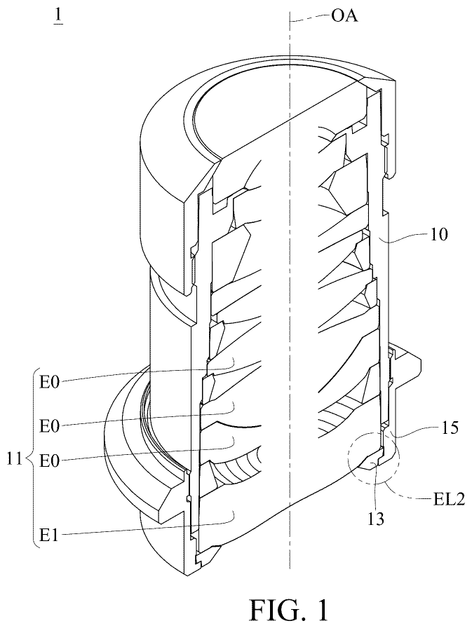

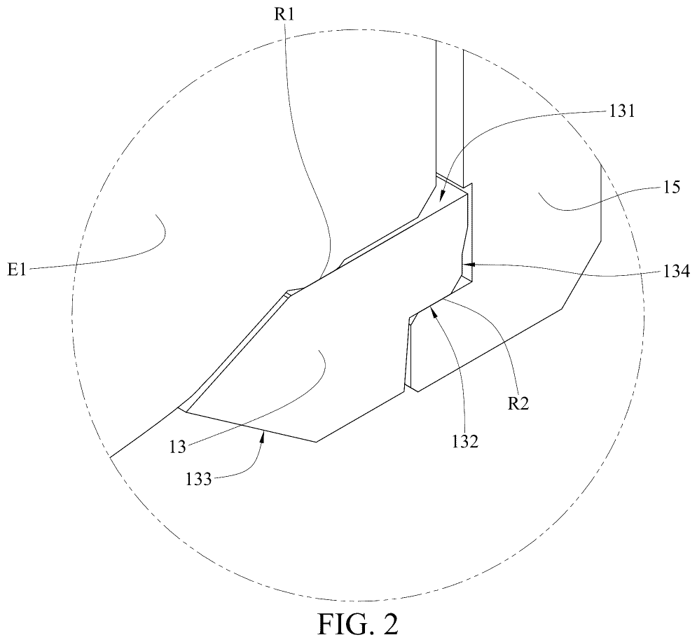

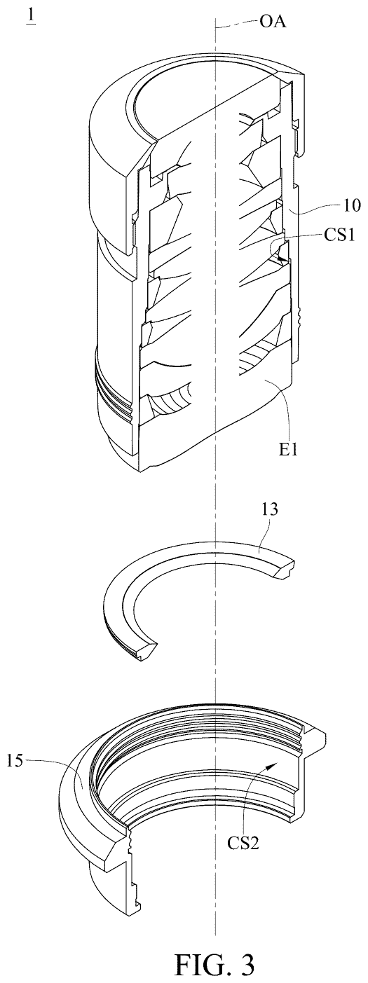

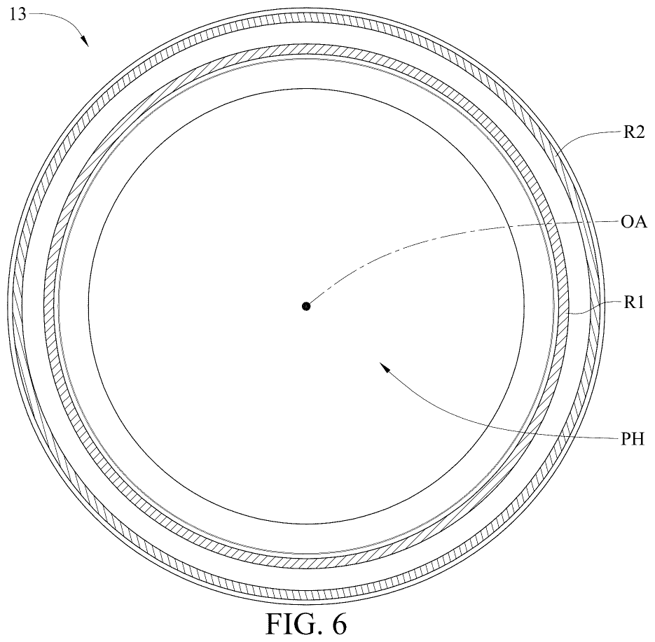

Please refer to FIG. 1 to FIG. 6. FIG. 1 is a sectional view of an optical lens according to the 1st embodiment of the present disclosure, FIG. 2 is an enlarged view of region EL2 in FIG. 1, FIG. 3 is an exploded view of the optical lens in FIG. 1, FIG. 4 is a cross-sectional view of the optical lens in FIG. 1, FIG. 5 is an enlarged view of region EL5 in FIG. 4, and FIG. 6 is a plan view of a spacer element of the optical lens according to the 1st embodiment of the present disclosure. To clearly illustrate the relative arrangement of the components, some components have been omitted or simplified. For example, the details of the lens group are not intended to limit the present disclosure; therefore, the detailed contours of the lens group are not depicted in the figures.

An optical lens 1 is provided in this embodiment. The optical lens 1 has an optical axis OA, and the optical lens 1 includes a lens barrel 10, a lens group 11, a spacer element 13 and a retaining element 15.

The optical axis OA of the optical lens 1 passes through the lens barrel 10, and the lens barrel 10 has a first annular surface CS1 surrounding the optical axis OA.

The lens group 11 includes a plurality of lens elements E0 and E1, which are sequentially arranged along the optical axis OA. At least one lens element in the lens group 11 is a plastic lens element, and at least one other lens element is a glass lens element, and the lens group 11 is arranged along the optical axis OA and disposed on the first annular surface CS1 of the lens barrel 10. Specifically, the lens elements E0 and E1 in the lens group 11 are sequentially arranged along the optical axis OA, and the lens elements E0 and E1 are all disposed on the first annular surface CS1 of the lens barrel 10. Moreover, the lens element E1 is made of plastic material and has a first region R1, and the first region R1 surrounds the optical axis OA.

The spacer element 13 is arranged adjacent to the lens element E1 and surrounds the optical axis OA, and the spacer element 13 is made of plastic material and has a first surface 131, a second surface 132, a near-axis side surface 133, and a far-axis side surface 134. As shown in FIG. 2 and FIG. 5, the first surface 131 is disposed opposite to the second surface 132, and the first region R1 of the lens element E1 is supported on the first surface 131 in a direction parallel to the optical axis OA. The near-axis side surface 133 is connected to the first surface 131 on a side closest to the optical axis OA and to the second surface 132 on a side closest to the optical axis OA. The near-axis side surface 133 surrounds the optical axis OA and gradually tapers toward the optical axis OA, forming a light-passing hole PH. The far-axis side surface 134 is connected to the first surface 131 on a side farthest from the optical axis OA and to the second surface 132 on a side farthest from the optical axis OA, and the far-axis side surface 134 is disposed opposite to the near-axis side surface 133.

As shown in FIG. 4 and FIG. 5, the retaining element 15 is made of metal material and is fixedly arranged with the lens barrel 10 to maintain a relative fixed position between the lens element E1 and the lens barrel 10 along the optical axis OA. Additionally, the spacer element 13 is disposed between the lens element E1 and the retaining element 15. The retaining element 15 has a second annular surface CS2 and a second region R2 both surrounding the optical axis OA, where the second annular surface CS2 faces the optical axis OA, and the second region R2 is supported on the second surface 132 of the spacer element 13 in a direction parallel to the optical axis OA. In this embodiment, the second annular surface CS2 of the retaining element 15 is assembled with the lens barrel 10 and abuts the spacer element 13.

Furthermore, the retaining element 15 includes a base portion 150, a retaining portion 151, and a barb structure 152. The base portion 150 is fixedly arranged with the lens barrel 10. The retaining portion 151 is connected to the base portion 150 and extends in a direction toward the optical axis OA, and the retaining portion 151 has the second region R2. The barb structure 152 is connected to the base portion 150 and extends in a direction toward the optical axis OA, and the barb structure 152 faces the lens element E1 and is spaced apart from the lens element E1. Moreover, the barb structure 152 is spaced apart from the retaining portion 151, and the spacer element 13 is disposed between the barb structure 152 and the retaining portion 151. Additionally, the barb structure 152 is located closer to the optical axis OA than the far-axis side surface 134 of the spacer element 13, and the barb structure 152 is located farther from the optical axis OA than the lens element E1.

The retaining element 15 and the spacer element 13 have a clearance fit with each other in a direction perpendicular to the optical axis OA. Specifically, the second annular surface CS2 of the retaining element 15 faces the far-axis side surface 134 of the spacer element 13, and a gap GP is formed between the second annular surface CS2 and the far-axis side surface 134. Additionally, the gap GP extends from the far-axis side surface 134 of the spacer element 13 toward the optical axis OA along the first surface 131. In this embodiment, as shown in FIG. 5, the gap GP overlaps with the second region R2 of the retaining element 15 in a direction parallel to the optical axis OA. Moreover, when a distance between the far-axis side surface 134 and the retaining element 15 in a direction perpendicular to the optical axis OA is SGD, the following condition is satisfied: SGD=0.03 mm.

As shown in FIG. 5 and FIG. 6, the first region R1 of the lens element E1 and the second region R2 of the retaining element 15 do not overlap in a direction parallel to the optical axis OA. It should be noted that the first region R1 and the second region R2 indicated in FIG. 6 refer to the positions where the first region R1 of the lens element E1 and the second region R2 of the retaining element 15 are respectively projected onto corresponding positions on the spacer element 13 in a direction parallel to the optical axis OA.

When a distance between the first region R1 and the second region R2 in a direction perpendicular to the optical axis OA is VG, the following condition is satisfied: VG=0.54 mm.

When the distance between the first region R1 and the second region R2 in the direction perpendicular to the optical axis OA is VG, and a distance between the first region R1 and the second region R2 in a direction parallel to the optical axis OA is HG, the following conditions are satisfied: VG=0.54 mm; HG=0.55 mm; and VG/HG=0.98.

As shown in FIG. 4 and FIG. 5, when a maximum distance between the spacer element 13 and a center of the lens element E1 is SL, and a distance between the far-axis side surface 134 of the spacer element 13 and the retaining element 15 in a direction perpendicular to the optical axis OA is SGD, the following conditions are satisfied: SL=7.32 mm; SGD=0.03 mm; and SL/(SL+SGD)=0.9959.

A cross-section parallel to the optical axis OA and passing through the optical axis OA is defined. Moreover, in the cross-section, when a length of the first region R1 in a direction perpendicular to the optical axis OA is RF1, and a length of the second region R2 in a direction perpendicular to the optical axis OA is RF2, the following conditions are satisfied: RF1=0.24 mm; RF2=0.23 mm; and RF1/RF2=1.04.

In this embodiment, as shown in FIG. 5, the retaining portion 151 of the retaining element 15 further has a stop surface TS1, and the spacer element 13 further has a counterpart stop surface TS2. The stop surface TS1 is disposed opposite to the counterpart stop surface TS2, and a distance between the stop surface TS1 and the counterpart stop surface TS2 gradually increases in a direction away from the second region R2. Moreover, the stop surface TS1 and the counterpart stop surface TS2 form an angle A1 in the cross-section parallel to the optical axis OA and passing through the optical axis OA, and the following condition is satisfied: A1=5 degrees.

When a length of the stop surface TS1 in the cross-section is SF, and a length of the counterpart stop surface TS2 in the cross-section is CSF, the following conditions are satisfied: SF=0.38 mm; CSF=0.43 mm; and SF/CSF=0.88.

### 2nd Embodiment

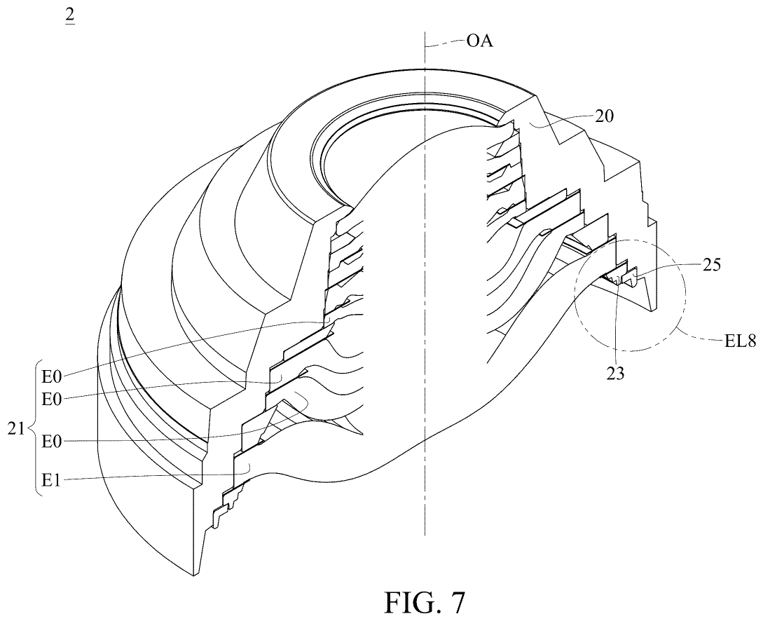

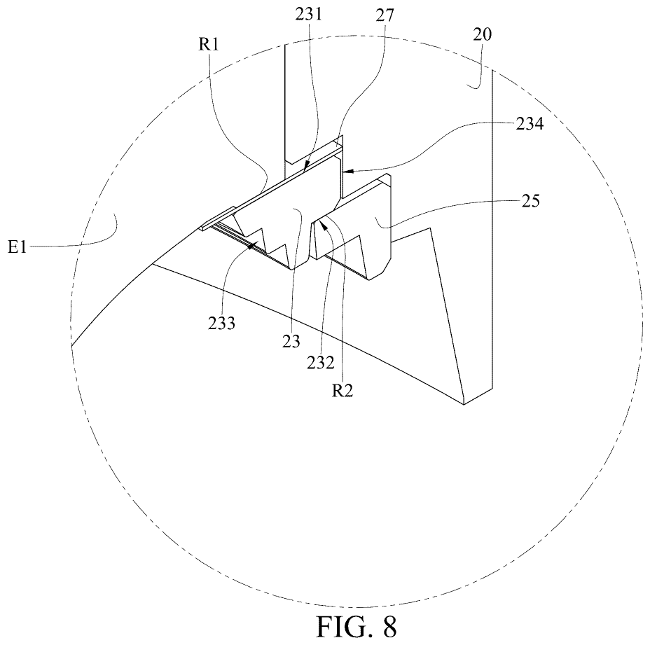

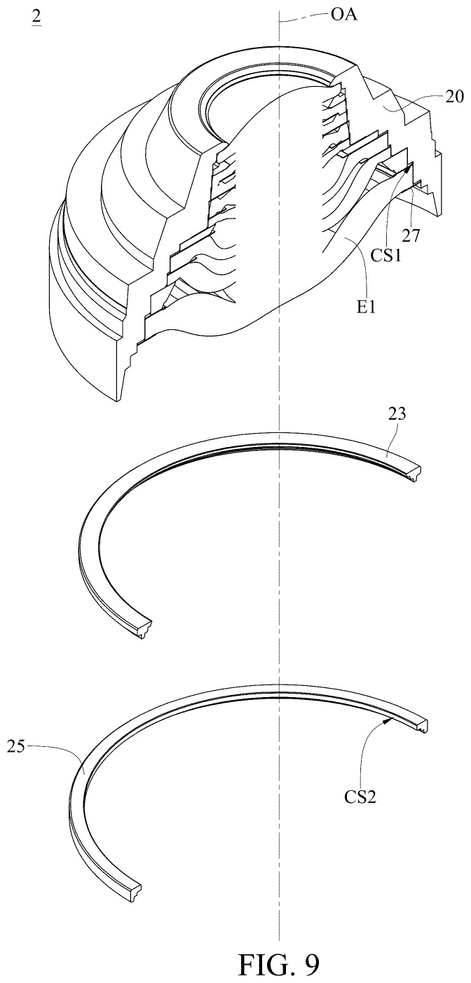

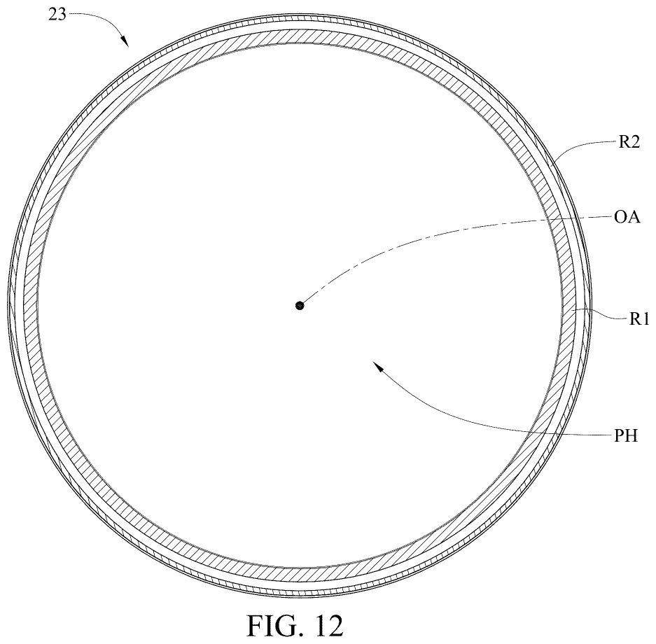

Please refer to FIG. 7 to FIG. 12. FIG. 7 is a sectional view of an optical lens according to the 2nd embodiment of the present disclosure, FIG. 8 is an enlarged view of region EL8 in FIG. 7, FIG. 9 is an exploded view of the optical lens in FIG. 7, FIG. 10 is a cross-sectional view of the optical lens in FIG. 7, FIG. 11 is an enlarged view of region EL11 in FIG. 10, and FIG. 12 is a plan view of a spacer element of the optical lens according to the 2nd embodiment of the present disclosure. To clearly illustrate the relative arrangement of the components, some components have been omitted or simplified. For example, the details of the lens group are not intended to limit the present disclosure; therefore, the detailed contours of the lens group are not depicted in the figures.

An optical lens 2 is provided in this embodiment. The optical lens 2 has an optical axis OA, and the optical lens 2 includes a lens barrel 20, a lens group 21, a spacer element 23, a retaining element 25, a light-blocking element 27 and a damper 29.

The optical axis OA of the optical lens 2 passes through lens barrel 20, and the lens barrel 20 has a first annular surface CS1 surrounding the optical axis OA.

The lens group 21 includes a plurality of lens elements E0 and E1, which are sequentially arranged along the optical axis OA. At least one lens element in the lens group 21 is a plastic lens element, and at least one other lens element is a glass lens element, and the lens group 21 is arranged along the optical axis OA and disposed on the first annular surface CS1 of the lens barrel 20. Specifically, the lens elements E0 and E1 in the lens group 21 are sequentially arranged along the optical axis OA, and the lens elements E0 and E1 are all disposed on the first annular surface CS1 of the lens barrel 20. Moreover, the lens element E1 is made of plastic material and has a first region R1 surrounding the optical axis OA.

The spacer element 23 is arranged adjacent to the lens element E1 and surrounds the optical axis OA, and the spacer element 23 is made of plastic material and has a first surface 231, a second surface 232, a near-axis side surface 233, and a far-axis side surface 234. As shown in FIG. 8 and FIG. 11, the first surface 231 is disposed opposite to the second surface 232, and the first region R1 of the lens element E1 is supported on the first surface 231 in a direction parallel to the optical axis OA. The near-axis side surface 233 is connected to the first surface 231 on a side closest to the optical axis OA and to the second surface 232 on a side closest to the optical axis OA., and the near-axis side surface 233 surrounds the optical axis OA and gradually tapers toward the optical axis OA, forming a light-passing hole PH. The far-axis side surface 234 is connected to the first surface 231 on the side farthest from the optical axis OA and to the second surface 232 on the side farthest from the optical axis OA, and the far-axis side surface 234 is disposed opposite to the near-axis side surface 233.

In this embodiment, as shown in FIG. 11, the near-axis side surface 233 of the spacer element 23 has an anti-reflective surface ARL, and a reflectance of the anti-reflective surface ARL is lower than a reflectance of the far-axis side surface 234.

The lens barrel 20 and the spacer element 23 have a clearance fit with each other in a direction perpendicular to the optical axis OA. Specifically, the first annular surface CS1 of the lens barrel 20 faces the far-axis side surface 234 of the spacer element 23, and a gap GP is formed between the first annular surface CS1 and the far-axis side surface 234. Additionally, the gap GP extends from the far-axis side surface 234 of the spacer element 23 toward the optical axis OA along the first surface 231. In this embodiment, as shown in FIG. 11, when a distance between the far-axis side surface 234 and the lens barrel 20 in a direction perpendicular to the optical axis OA is SG, the following condition is satisfied: SG=0.02 mm.

The light-blocking element 27 is disposed between the lens element E1 and the spacer element 23, and the light-blocking element 27 surrounds the optical axis OA. Moreover, the first region R1 of the lens element E1 is indirectly supported on the first surface 231 of the spacer element 23 through the light-blocking element 27 in a direction parallel to the optical axis OA.

The damper 29 is disposed in the gap GP. In this embodiment, the damper 29 is located between the first annular surface CS1 of the lens barrel 20 and the far-axis side surface 234 of the spacer element 23, but the present disclosure is not limited thereto.

As shown in FIG. 10 and FIG. 11, the retaining element 25 is made of metal material and is fixedly arranged with the lens barrel 20 to maintain a relative fixed position between the lens element E1 and the lens barrel 20 along the optical axis OA. Additionally, the spacer element 23 is disposed between the lens element E1 and the retaining element 25. The retaining element 25 has a second annular surface CS2 and a second region R2 both surrounding the optical axis OA, where the second annular surface CS2 faces the optical axis OA, and the second region R2 is supported on the second surface 232 of the spacer element 23 in a direction parallel to the optical axis OA. Furthermore, the retaining element 25 includes a base portion 250 and a retaining portion 251. The base portion 250 is fixedly arranged with the lens barrel 20. The retaining portion 251 is connected to the base portion 250 and extends in a direction toward the optical axis OA, and the retaining portion 251 has the second region R2. In this embodiment, as shown in FIG. 11, the gap GP overlaps with the second region R2 in a direction parallel to the optical axis OA.

As shown in FIG. 11 and FIG. 12, the first region R1 of the lens element E1 and the second region R2 of the retaining element 25 do not overlap in a direction parallel to the optical axis OA. It should be noted that the first region R1 and the second region R2 indicated in FIG. 12 refer to the positions where the first region R1 of the lens element E1 and the second region R2 of the retaining element 25 are respectively projected onto corresponding positions on the spacer element 23 in a direction parallel to the optical axis OA.

When a distance between the first region R1 and the second region R2 in a direction perpendicular to the optical axis OA is VG, the following condition is satisfied: VG=0.22 mm.

When the distance between the first region R1 and the second region R2 in the direction perpendicular to the optical axis OA is VG, and a distance between the first region R1 and the second region R2 in a direction parallel to the optical axis OA is HG, the following conditions are satisfied: VG=0.22 mm; HG=0.34 mm; and VG/HG=0.65.

As shown in FIG. 10 and FIG. 11, when a maximum distance between the spacer element 23 and a center of the lens element E1 is SL, and the distance between the far-axis side surface 234 of the spacer element 23 and the lens barrel 20 in the direction perpendicular to the optical axis OA is SG, the following conditions are satisfied: SL=7.28 mm; SG=0.02 mm; and SL/(SL+SG)=0.9973.

A cross-section parallel to the optical axis OA and passing through the optical axis OA is defined. Moreover, in the cross-section, when a length of the first region R1 in a direction perpendicular to the optical axis OA is RF1, and a length of the second region R2 in a direction perpendicular to the optical axis OA is RF2, the following conditions are satisfied: RF1=0.32 mm; RF2=0.13 mm; and RF1/RF2=2.46.

In this embodiment, as shown in FIG. 11, the retaining portion 251 of the retaining element 25 further has a stop surface TS1, and the spacer element 23 further has a counterpart stop surface TS2. The stop surface TS1 is disposed opposite to the counterpart stop surface TS2, and a distance between the stop surface TS1 and the counterpart stop surface TS2 gradually increases in a direction away from the second region R2. Moreover, the stop surface TS1 and the counterpart stop surface TS2 form an angle A1 in the cross-section parallel to the optical axis OA and passing through the optical axis OA, and the following condition is satisfied: A1=10 degrees.

When a length of the stop surface TS1 in the cross-section is SF, and a length of the counterpart stop surface TS2 in the cross-section is CSF, the following conditions are satisfied: SF=0.23 mm; CSF=0.19 mm; and SF/CSF=1.21.

### 3rd Embodiment

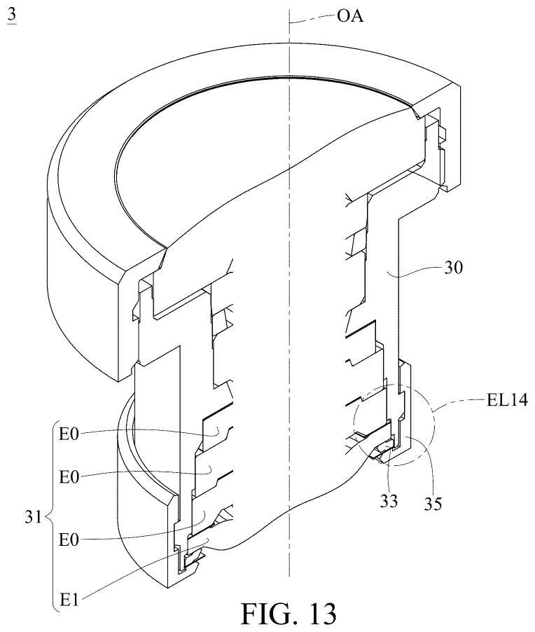

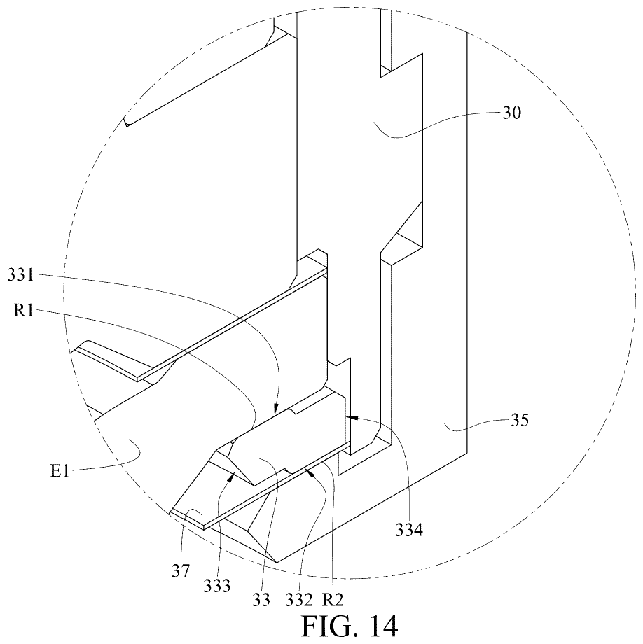

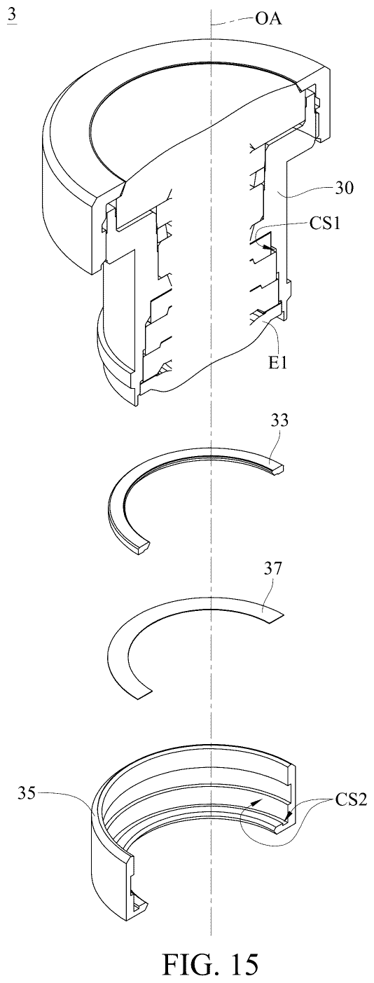

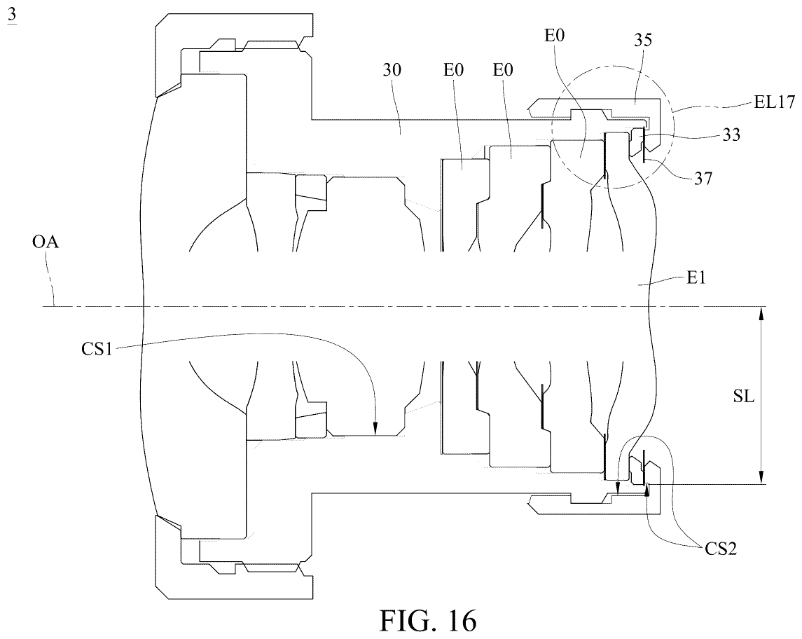

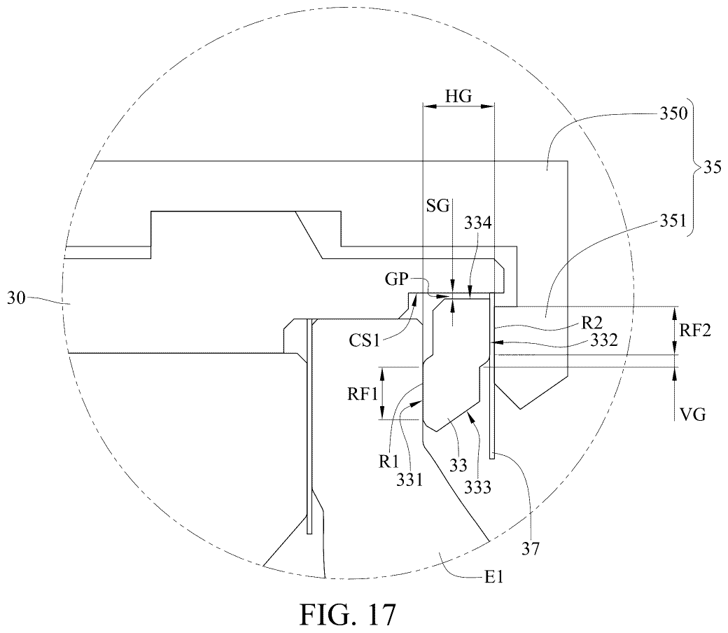

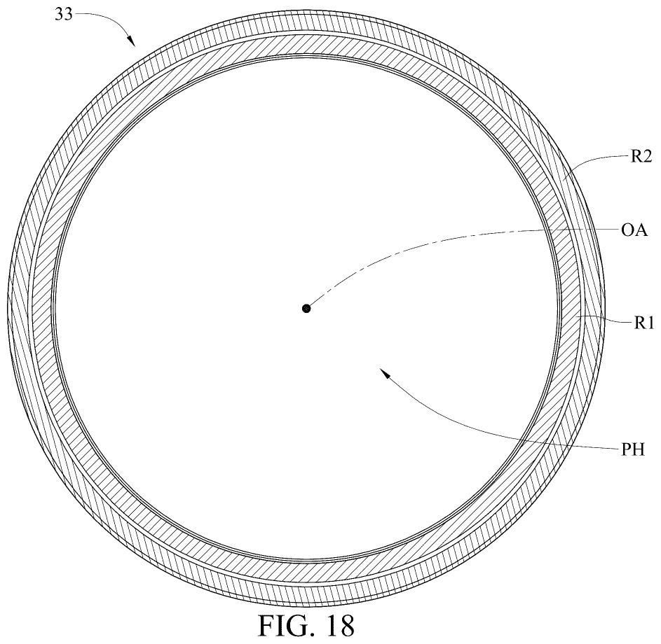

Please refer to FIG. 13 to FIG. 18. FIG. 13 is a sectional view of an optical lens according to the 3rd embodiment of the present disclosure, FIG. 14 is an enlarged view of region EL14 in FIG. 13, FIG. 15 is an exploded view of the optical lens in FIG. 13, FIG. 16 is a cross-sectional view of the optical lens in FIG. 13, FIG. 17 is an enlarged view of region EL17 in FIG. 16, and FIG. 18 is a plan view of a spacer element of the optical lens according to the 3rd embodiment of the present disclosure. To clearly illustrate the relative arrangement of the components, some components have been omitted or simplified. For example, the details of the lens group are not intended to limit the present disclosure; therefore, the detailed contours of the lens group are not depicted in the figures.

An optical lens 3 is provided in this embodiment. The optical lens 3 has an optical axis OA, and the optical lens 3 includes a lens barrel 30, a lens group 31, a spacer element 33, a retaining element 35 and a light-blocking element 37.

The optical axis OA of the optical lens 3 passes through the lens barrel 30, and the lens barrel 30 has a first annular surface CS1 surrounding the optical axis OA.

The lens group 31 includes a plurality of lens elements E0 and E1, which are sequentially arranged along the optical axis OA. At least one lens element in the lens group 31 is a plastic lens element, at least one other lens element is a glass lens element, and the lens group 31 is arranged along the optical axis OA and disposed on the first annular surface CS1 of the lens barrel 30. Specifically, the lens elements E0 and E1 in the lens group 31 are sequentially arranged along the optical axis OA, and the lens elements E0 and E1 are all disposed on the first annular surface CS1 of the lens barrel 30. Moreover, the lens element E1 is made of plastic material and has a first region R1 surrounding the optical axis OA.

The spacer element 33 is arranged adjacent to the lens element E1 and surrounds the optical axis OA, and the spacer element 33 is made of plastic material and has a first surface 331, a second surface 332, a near-axis side surface 333, and a far-axis side surface 334. As shown in FIG. 14 and FIG. 17, the first surface 331 is disposed opposite to the second surface 332, and the first region R1 of the lens element E1 is supported on the first surface 331 in a direction parallel to the optical axis OA. The near-axis side surface 333 is connected to the first surface 331 on a side closest to the optical axis OA and to the second surface 332 on a side closest to the optical axis OA, and the near-axis side surface 333 surrounds the optical axis OA and gradually tapers toward the optical axis OA, forming a light-passing hole PH. The far-axis side surface 334 is connected to the first surface 331 on a side farthest from the optical axis OA and to the second surface 332 on a side farthest from the optical axis OA, and the far-axis side surface 334 is disposed opposite to the near-axis side surface 333.

The lens barrel 30 and the spacer element 33 have a clearance fit with each other in a direction perpendicular to the optical axis OA. Specifically, the first annular surface CS1 of the lens barrel 30 faces the far-axis side surface 334 of the spacer element 33, and a gap GP is formed between the first annular surface CS1 and the far-axis side surface 334. Additionally, the gap GP extends from the far-axis side surface 334 of the spacer element 33 toward the optical axis OA along the first surface 331. In this embodiment, as shown in FIG. 17, when a distance between the far-axis side surface 334 and the lens barrel 30 in a direction perpendicular to the optical axis OA is SG, the following condition is satisfied: SG=0.03 mm.

As shown in FIG. 16 and FIG. 17, the retaining element 35 is made of metal material and is fixedly arranged with the lens barrel 30 to maintain a relative fixed position between the lens element E1 and the lens barrel 30 along the optical axis OA. Additionally, the spacer element 33 is disposed between the lens element E1 and the retaining element 35. The retaining element 35 has a second annular surface CS2 and a second region R2 both surrounding the optical axis OA, where the second annular surface CS2 at least partially faces the optical axis OA, and the second region R2 is supported on the second surface 332 of the spacer element 33 in a direction parallel to the optical axis OA. In this embodiment, the second annular surface CS2 of the retaining element 35 abuts the lens barrel 30, is assembled with the lens barrel 30, and abuts the second surface 332 of the spacer element 33.

Furthermore, the retaining element 35 includes a base portion 350 and a retaining portion 351. The base portion 350 is fixedly arranged with the lens barrel 30. The retaining portion 351 is connected to the base portion 350 and extends in a direction toward the optical axis OA, and the retaining portion 351 has the second region R2. In this embodiment, as shown in FIG. 17, the gap GP overlaps with the second region R2 in a direction parallel to the optical axis OA.

The light-blocking element 37 is disposed between the spacer element 33 and the retaining element 35, and the light-blocking element 37 surrounds the optical axis OA. Moreover, the second region R2 of the retaining element 35 is indirectly supported on the second surface 332 of the spacer element 33 through the light-blocking element 37 in a direction parallel to the optical axis OA.

As shown in FIG. 17 and FIG. 18, the first region R1 of the lens element E1 and the second region R2 of the retaining element 35 do not overlap in a direction parallel to the optical axis OA. It should be noted that the first region R1 and the second region R2 indicated in FIG. 18 refer to the positions where the first region R1 of the lens element E1 and the second region R2 of the retaining element 35 are respectively projected onto corresponding positions on the spacer element 33 in a direction parallel to the optical axis OA.

When a distance between the first region R1 and the second region R2 in a direction perpendicular to the optical axis OA is VG, the following condition is satisfied: VG=0.06 mm.

When the distance between the first region R1 and the second region R2 in the direction perpendicular to the optical axis OA is VG, and a distance between the first region R1 and the second region R2 in a direction parallel to the optical axis OA is HG, the following conditions are satisfied: VG=0.06 mm; HG=0.36 mm; and VG/HG=0.17.

As shown in FIG. 16 and FIG. 17, when a maximum distance between the spacer element 33 and a center of the lens element E1 is SL, and the distance between the far-axis side surface 334 of the spacer element 33 and the lens barrel 30 in the direction perpendicular to the optical axis OA is SG, the following conditions are satisfied: SL=4.13 mm; SG=0.03 mm; and SL/(SL+SG)=0.9928.

A cross-section parallel to the optical axis OA and passing through the optical axis OA is defined. Moreover, in the cross-section, when a length of the first region R1 in a direction perpendicular to the optical axis OA is RF1, and a length of the second region R2 in a direction perpendicular to the optical axis OA is RF2, the following conditions are satisfied: RF1=0.26 mm; RF2=0.24 mm; and RF1/RF2=1.08.

### 4th Embodiment

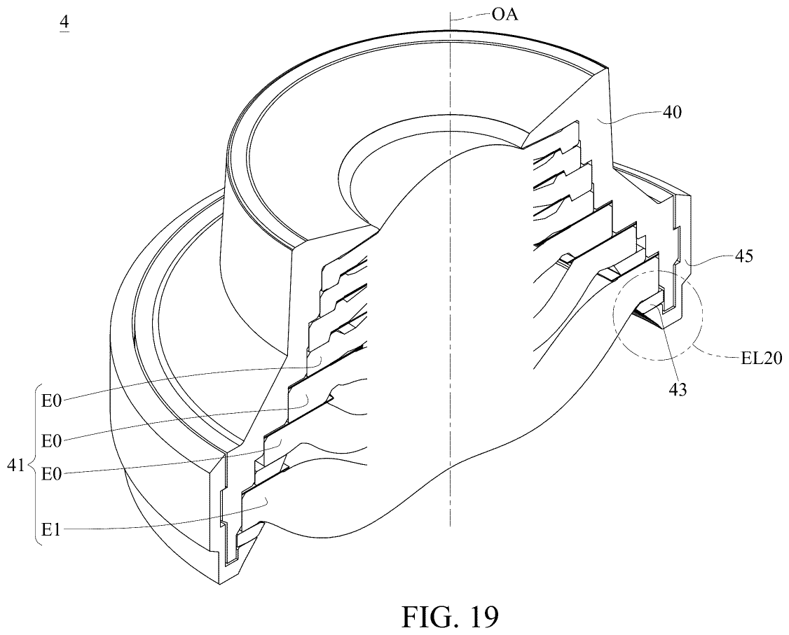

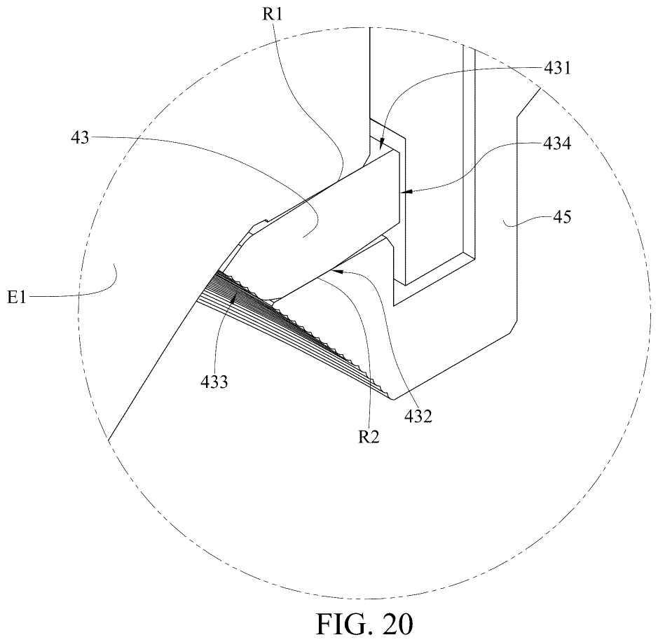

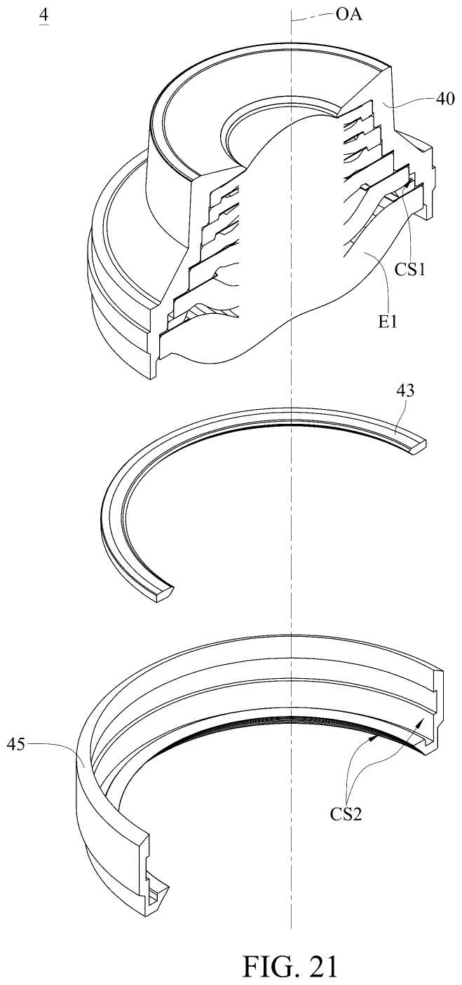

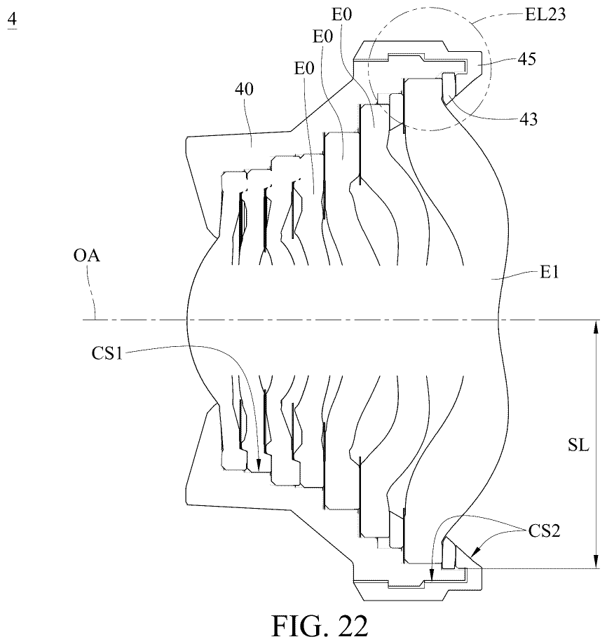

Please refer to FIG. 19 to FIG. 24. FIG. 19 is a sectional view of an optical lens according to the 4th embodiment of the present disclosure, FIG. 20 is an enlarged view of region EL20 in FIG. 19, FIG. 21 is an exploded view of the optical lens in FIG. 19, FIG. 22 is a cross-sectional view of the optical lens in FIG. 19, FIG. 23 is an enlarged view of region EL23 in FIG. 22, and FIG. 24 is a plan view of a spacer element of the optical lens according to the 4th embodiment of the present disclosure. To clearly illustrate the relative arrangement of the components, some components have been omitted or simplified. For example, the details of the lens group are not intended to limit the present disclosure; therefore, the detailed contours of the lens group are not depicted in the figures.

An optical lens 4 is provided in this embodiment. The optical lens 4 has an optical axis OA, and the optical lens 4 includes a lens barrel 40, a lens group 41, a spacer element 43 and a retaining element 45.

The optical axis OA of the optical lens 4 passes through the lens barrel 40, and the lens barrel 40 has a first annular surface CS1 surrounding the optical axis OA.

The lens group 41 includes a plurality of lens elements E0 and E1, which are sequentially arranged along the optical axis OA. At least one lens element in the lens group 41 is a plastic lens element, at least one other lens element is a glass lens element, and the lens group 41 is arranged along the optical axis OA and disposed on the first annular surface CS1 of the lens barrel 40. Specifically, the lens elements E0 and E1 in the lens group 41 are sequentially arranged along the optical axis OA, and the lens elements E0 and E1 are all disposed on the first annular surface CS1 of the lens barrel 40. Moreover, the lens element E1 is made of plastic material and has a first region R1 surrounding the optical axis OA.

The spacer element 43 is arranged adjacent to the lens element E1 and surrounds the optical axis OA, and the spacer element 43 is made of plastic material and has a first surface 431, a second surface 432, a near-axis side surface 433, and a far-axis side surface 434. As shown in FIG. 20 and FIG. 23, the first surface 431 is disposed opposite to the second surface 432, and the first region R1 of the lens element E1 is supported on the first surface 431 in a direction parallel to the optical axis OA. The near-axis side surface 433 is connected to the first surface 431 on a side closest to the optical axis OA and to the second surface 432 on a side closest to the optical axis OA, and the near-axis side surface 433 surrounds the optical axis OA and gradually tapers toward the optical axis OA, forming a light-passing hole PH. The far-axis side surface 434 is connected to the first surface 431 on a side farthest from the optical axis OA and to the second surface 432 on a side farthest from the optical axis OA, and the far-axis side surface 434 is disposed opposite to the near-axis side surface 433.

In this embodiment, as shown in FIG. 23, the near-axis side surface 433 of the spacer element 43 has an anti-reflective surface ARL, and a reflectance of the anti-reflective surface ARL is lower than a reflectance of the far-axis side surface 434.

The lens barrel 40 and the spacer element 43 have a clearance fit with each other in a direction perpendicular to the optical axis OA. Specifically, the first annular surface CS1 of the lens barrel 40 faces the far-axis side surface 434 of the spacer element 43, and a gap GP is formed between the first annular surface CS1 and the far-axis side surface 434. Additionally, the gap GP extends from the far-axis side surface 434 of the spacer element 43 toward the optical axis OA along the second surface 432. In this embodiment, as shown in FIG. 23, when a distance between the far-axis side surface 434 and the lens barrel 40 in a direction perpendicular to the optical axis OA is SG, the following condition is satisfied: SG=0.02 mm.

As shown in FIG. 22 and FIG. 23, the retaining element 45 is made of metal material and is fixedly arranged with the lens barrel 40 to maintain a relative fixed position between the lens element E1 and the lens barrel 40 along the optical axis OA. Additionally, the spacer element 43 is disposed between the lens element E1 and the retaining element 45. The retaining element 45 has a second annular surface CS2 and a second region R2 both surrounding the optical axis OA, where the second annular surface CS2 at least partially faces the optical axis OA, and the second region R2 is supported on the second surface 432 of the spacer element 43 in a direction parallel to the optical axis OA. In this embodiment, the second annular surface CS2 of the retaining element 45 abuts the lens barrel 40, is assembled with the lens barrel 40, and abuts the second surface 432 of the spacer element 43.

Furthermore, the retaining element 45 includes a base portion 450 and a retaining portion 451. The base portion 450 is fixedly arranged with the lens barrel 40. The retaining portion 451 is connected to the base portion 450 and extends in a direction toward the optical axis OA, and the retaining portion 451 has the second region R2. In this embodiment, as shown in FIG. 23, the gap GP overlaps with the first region R1 in a direction parallel to the optical axis OA.

As shown in FIG. 23 and FIG. 24, the first region R1 of the lens element E1 and the second region R2 of the retaining element 45 do not overlap in a direction parallel to the optical axis OA. It should be noted that the first region R1 and the second region R2 indicated in FIG. 24 refer to the positions where the first region R1 of the lens element E1 and the second region R2 of the retaining element 45 are respectively projected onto corresponding positions on the spacer element 43 in a direction parallel to the optical axis OA.

When a distance between the first region R1 and the second region R2 in a direction perpendicular to the optical axis OA is VG, the following condition is satisfied: VG=0.02 mm.

When the distance between the first region R1 and the second region R2 in the direction perpendicular to the optical axis OA is VG, and a distance between the first region R1 and the second region R2 in a direction parallel to the optical axis OA is HG, the following conditions are satisfied: VG=0.02 mm; HG=0.31 mm; and VG/HG=0.06.

As shown in FIG. 22 and FIG. 23, when a maximum distance between the spacer element 43 and a center of the lens element E1 is SL, and the distance between the far-axis side surface 434 of the spacer element 43 and the lens barrel 40 in the direction perpendicular to the optical axis OA is SG, the following conditions are satisfied: SL=5.74 mm; SG=0.02 mm; and SL/(SL+SG)=0.9965.

A cross-section parallel to the optical axis OA and passing through the optical axis OA is defined. Moreover, in the cross-section, when a length of the first region R1 in a direction perpendicular to the optical axis OA is RF1, and a length of the second region R2 in a direction perpendicular to the optical axis OA is RF2, the following conditions are satisfied: RF1=0.1 mm; RF2=0.21 mm; and RF1/RF2=0.48.

In this embodiment, as shown in FIG. 23, the retaining portion 451 of the retaining element 45 further has a stop surface TS1, and the spacer element 43 further has a counterpart stop surface TS2. The stop surface TS1 is disposed opposite to the counterpart stop surface TS2, and a distance between the stop surface TS1 and the counterpart stop surface TS2 gradually increases in a direction away from the second region R2. Moreover, the stop surface TS1 and the counterpart stop surface TS2 form an angle A1 in the cross-section parallel to the optical axis OA and passing through the optical axis OA, and the following condition is satisfied: A1=6 degrees.

When a length of the stop surface TS1 in the cross-section is SF, and a length of the counterpart stop surface TS2 in the cross-section is CSF, the following conditions are satisfied: SF=0.23 mm; CSF=0.28 mm; and SF/CSF=0.82.

In this embodiment, as shown in FIG. 24, the spacer element 43 is an annular element, but the present disclosure is not limited thereto. For example, please refer to FIG. 25 and FIG. 26, where FIG. 25 is a plan view of a spacer element of an optical lens according to one configuration of the present disclosure, and FIG. 26 is a plan view of a spacer element of an optical lens according to another configuration of the present disclosure.

In the configuration shown in FIG. 25, the spacer element 53 is an arc-shaped element with a single cut edge, and the shape of the spacer element 53 may, for example, be designed to correspond to a lens element with a single cut edge, but the present disclosure is not limited thereto.

In the configuration shown in FIG. 26, the spacer element 63 is an arc-shaped element with a pair of cut edges, and the shape of the spacer element 63 may, for example, be designed to correspond to a lens element with a pair of cut edges, but the disclosure invention is not limited thereto.

### 5th Embodiment

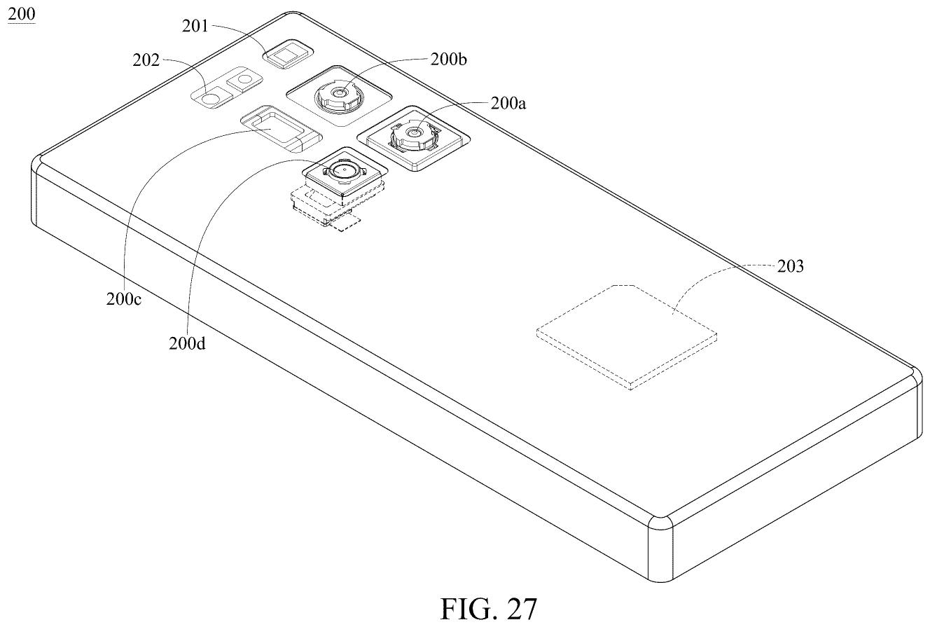

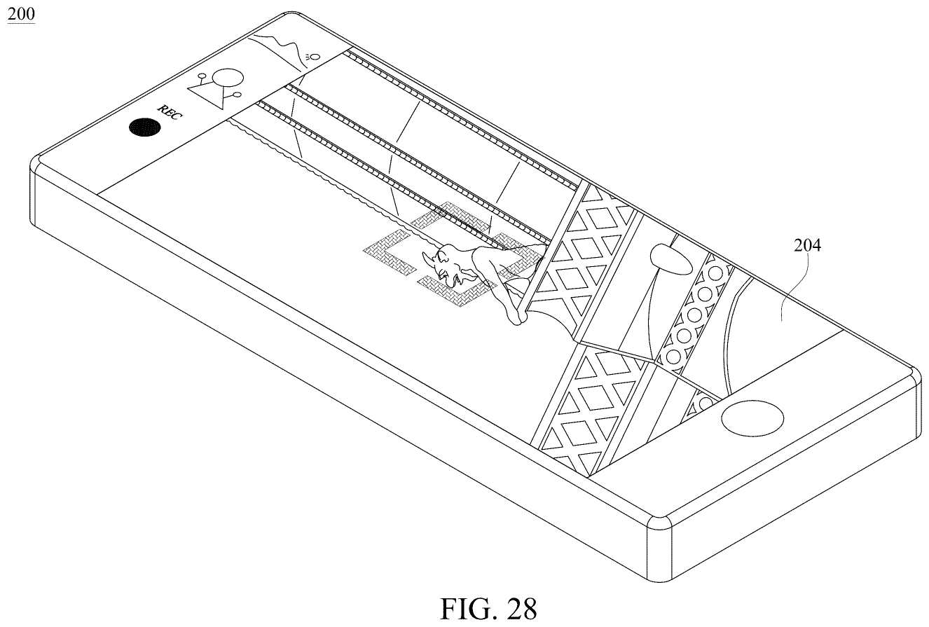

Please refer to FIG. 27 and FIG. 28. FIG. 27 is a perspective view of an electronic device according to the 5th embodiment of the present disclosure, and FIG. 28 is another perspective view of the electronic device in FIG. 27.

In this embodiment, the electronic device 200 is a smartphone including a plurality of camera modules 200a, 200b, 200c and 200d, a flash module 201, a focus assist module 202, an image signal processor 203, a display module (user interface) 204, and an image software processor (not shown).

These camera modules include an ultra-wide-angle camera module 200a, a high pixel camera module 200b, a telephoto camera module 200c and a telephoto camera module 200d. Moreover, the telephoto camera module 200d includes the optical lens of the present disclosure and an image sensor (not shown), where the image sensor is disposed on an image surface of the optical lens, but the present disclosure is not limited thereto. Each of the camera modules 200a, 200b and 200c can include the optical lens of the present disclosure.

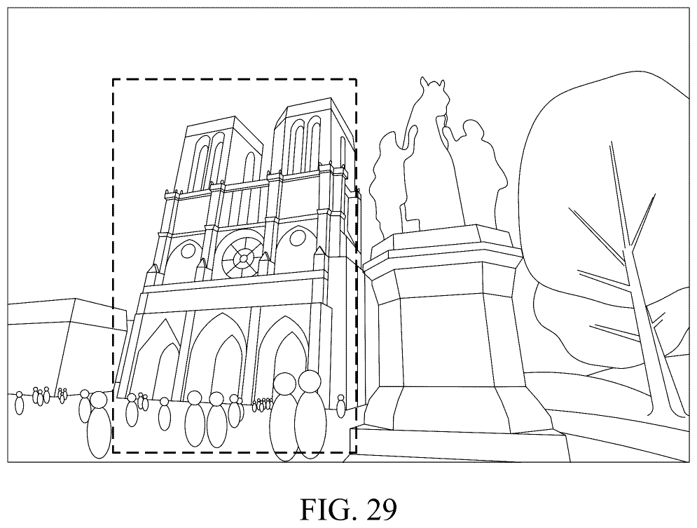

The image captured by the ultra-wide-angle camera module 200a enjoys a feature of multiple imaged objects. FIG. 29 is an image captured by the ultra-wide-angle camera module 200a.

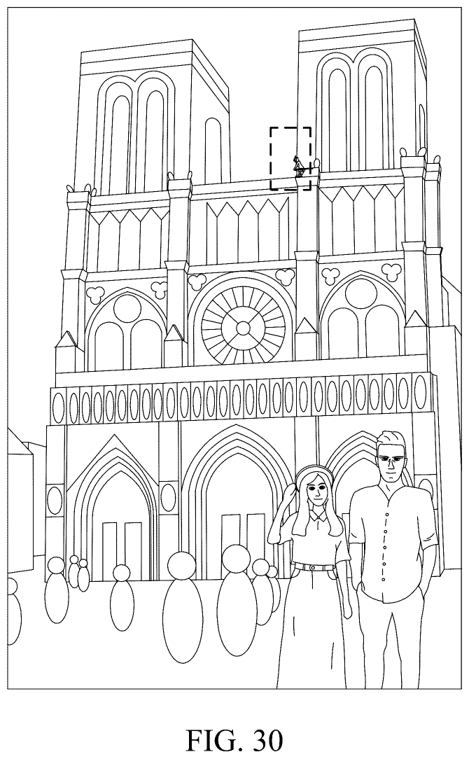

The image captured by the high pixel camera module 200b enjoys a feature of high resolution and less distortion, and the high pixel camera module 200b can capture part of the image in FIG. 29. FIG. 30 is an image captured by the high pixel camera module 200b.

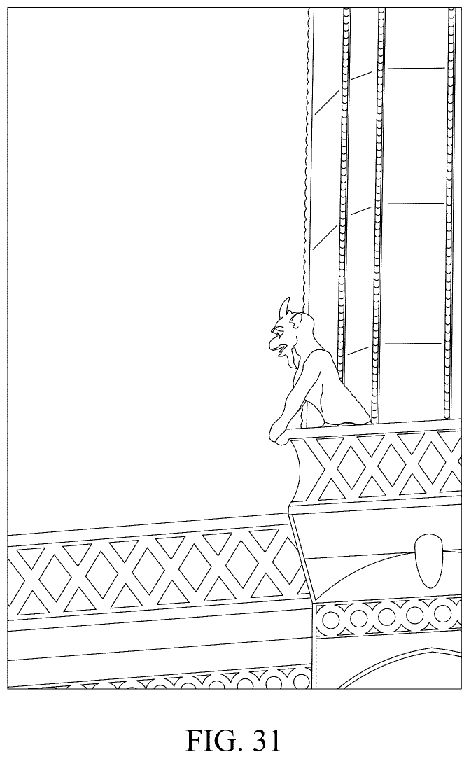

The image captured by the telephoto camera module 200c or the telephoto camera module 200d enjoys a feature of high optical magnification, and the telephoto camera module 200c or the telephoto camera module 200d can capture part of the image in FIG. 30. FIG. 31 is an image captured by the telephoto camera module 200c or the telephoto camera module 200d.

When a user captures images of an object, the light rays converge in the ultra-wide-angle camera module 200a, the high pixel camera module 200b, the telephoto camera module 200c or the telephoto camera module 200d to generate images, and the flash module 201 is activated for light supplement. The focus assist module 202 detects the object distance of the imaged object to achieve fast auto focusing. The image signal processor 203 is configured to optimize the captured image to improve image quality and provided zooming function. The light beam emitted from the focus assist module 202 can be either conventional infrared or laser. The display module 204 can include a touch screen, and the user is able to interact with the display module 204 to adjust the angle of view and switch between different camera modules, and the image software processor having multiple functions to capture images and complete image processing. Alternatively, the user may capture images via a physical button. The image processed by the image software processor can be displayed on the display module 204.

### 6th Embodiment

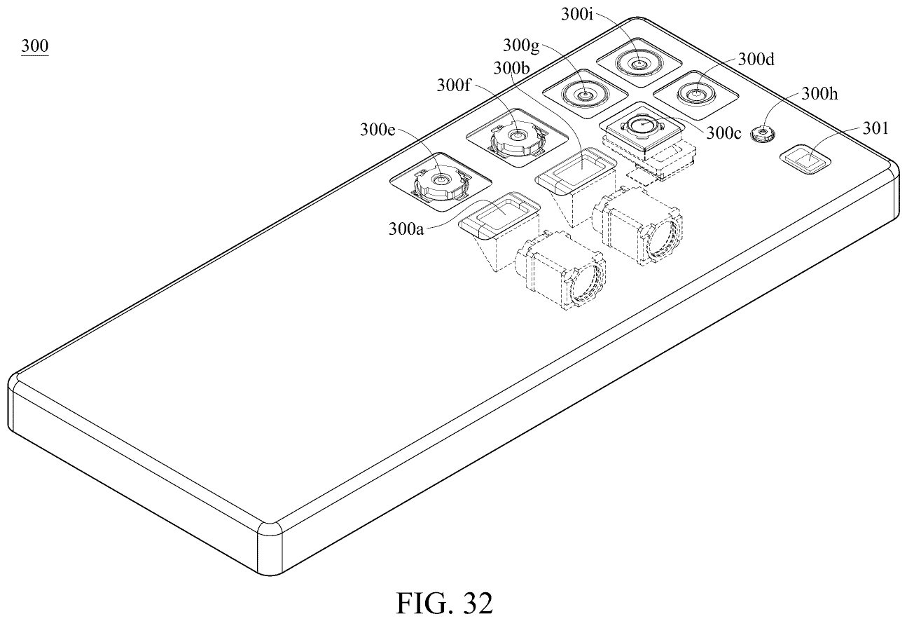

Please refer to FIG. 32, which is a perspective view of an electronic device according to the 6th embodiment of the present disclosure.

In this embodiment, the electronic device 300 is a smartphone including a camera module 300a, a camera module 300b, a camera module 300c, a camera module 300d, a camera module 300e, a camera module 300f, a camera module 300g, a camera module 300h, a camera module 300i, a flash module 301, an image signal processor, a display module, and an image software processor (not shown). The camera module 300a, the camera module 300b, the camera module 300c, the camera module 300d, the camera module 300e, the camera module 300f, the camera module 300g, the camera module 300h and the camera module 300i are disposed on the same side of the electronic device 300, while the display module is disposed on the opposite side of the electronic device 300. Moreover, the camera module 300c includes the optical lens of the present disclosure and an image sensor (not shown), and the image sensor is disposed on an image surface of the optical lens.

The camera module 300a is a telephoto camera module with optical path folding function, the camera module 300b is a telephoto camera module with optical path folding function, the camera module 300c is a telephoto camera module, the camera module 300d is a telephoto camera module, the camera module 300e is a wide-angle camera module, the camera module 300f is a wide-angle camera module, the camera module 300g is a ultra-wide-angle camera module, the camera module 300h is a ToF (time of flight) camera module, and the camera module 300i is an ultra-wide-angle camera module. In this embodiment, the camera module 300i, the camera module 300a, the camera module 300b, the camera module 300c, the camera module 300d, the camera module 300e, the camera module 300f and the camera module 300g have different fields of view, such that the electronic device 300 can have various magnification ratios so as to meet the requirement of optical zoom functionality. In addition, the camera module 300a and camera module 300b are telephoto camera modules having a light-folding element configuration. In addition, the camera module 300h can determine depth information of the imaged object. In this embodiment, the electronic device 300 includes multiple camera modules 300a, 300b, 300c, 300d, 300e, 300f, 300g, 300h, and 300i, but the present disclosure is not limited to the number and arrangement of camera modules. When a user captures images of an object, the light rays converge in the camera module 300a, the camera module 300b, the camera module 300c, the camera module 300d, the camera module 300e, the camera module 300f, the camera module 300g, the camera module 300h or the camera module 300i to generate an image(s), and the flash module 301 is activated for light supplement. Further, the subsequent processes are performed in a manner similar to the abovementioned embodiments, so the details in this regard will not be provided again.

### 7th Embodiment

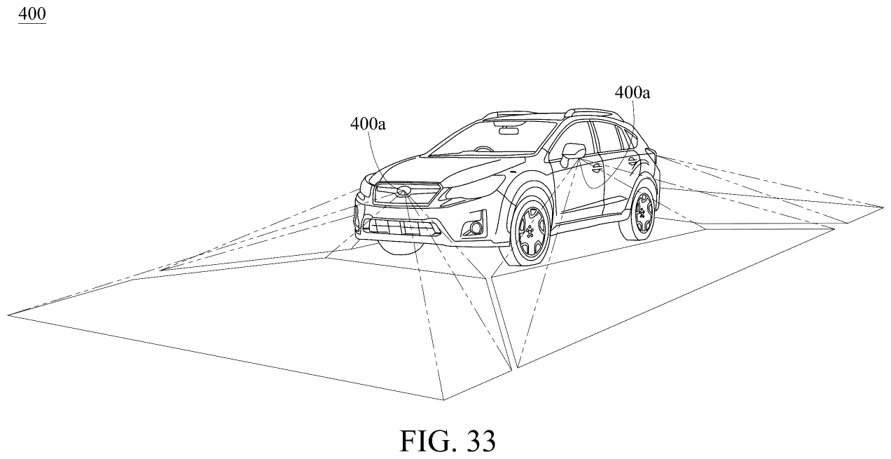

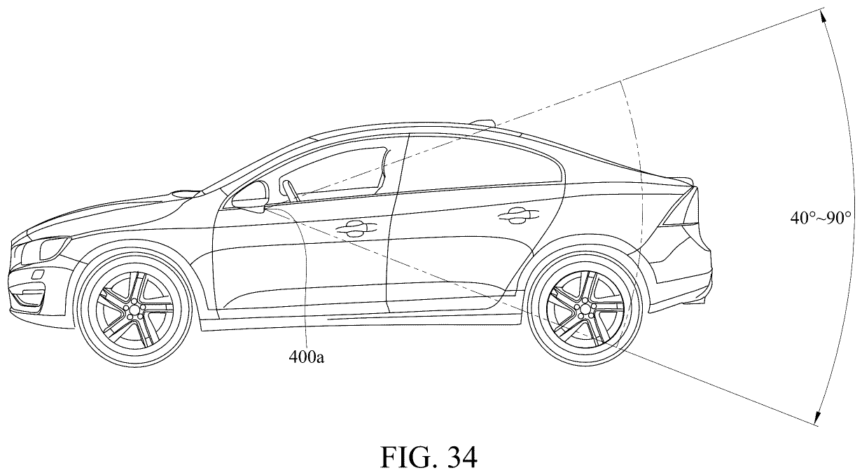

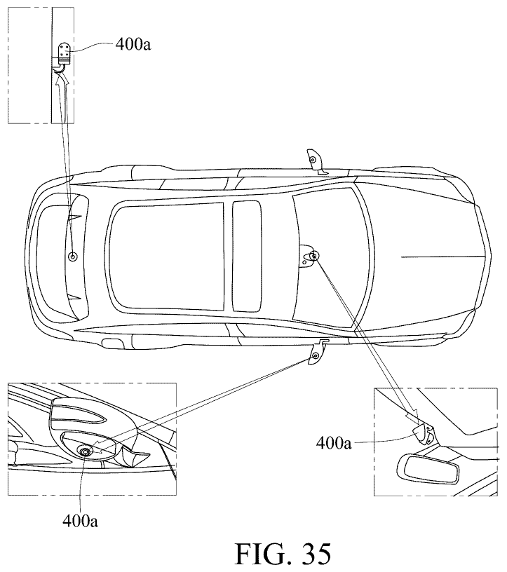

Please refer to FIG. 33 to FIG. 35. FIG. 33 is a perspective view of an electronic device according to the 7th embodiment of the present disclosure, FIG. 34 is a side view of the electronic device in FIG. 33, and FIG. 35 is a top view of the electronic device in FIG. 33.

In this embodiment, the electronic device 400 is an automobile. The electronic device 400 includes a plurality of automotive camera modules 400a, and the camera modules 400a each include the optical lens of the present disclosure and an image sensor disposed on an image surface of the optical lens. The camera modules 400a can serve as, for example, panoramic view car cameras, dashboard cameras and vehicle backup cameras.

As shown in FIG. 33, the camera modules 400a are, for example, disposed around the automobile to capture peripheral images of the automobile, which is favorable for obtaining external traffic information so as to achieve autopilot function. In addition, the image software processor may stitch the peripheral images into one panoramic view image for the driver's checking every corner surrounding the automobile, thereby favorable for parking and driving.

As shown in FIG. 34, the camera modules 400a are, for example, respectively disposed on the lower portion of the side mirrors. The field of view of the camera modules 400a can be 40 degrees to 90 degrees for capturing images in regions on left and right lanes.

As shown in FIG. 35, the camera modules 400a can also be, for example, respectively disposed on the lower portion of the side mirrors and inside the front and rear windshields for providing external information to the driver, and also providing more viewing angles so as to reduce blind spots, thereby improving driving safety.

### 8th Embodiment

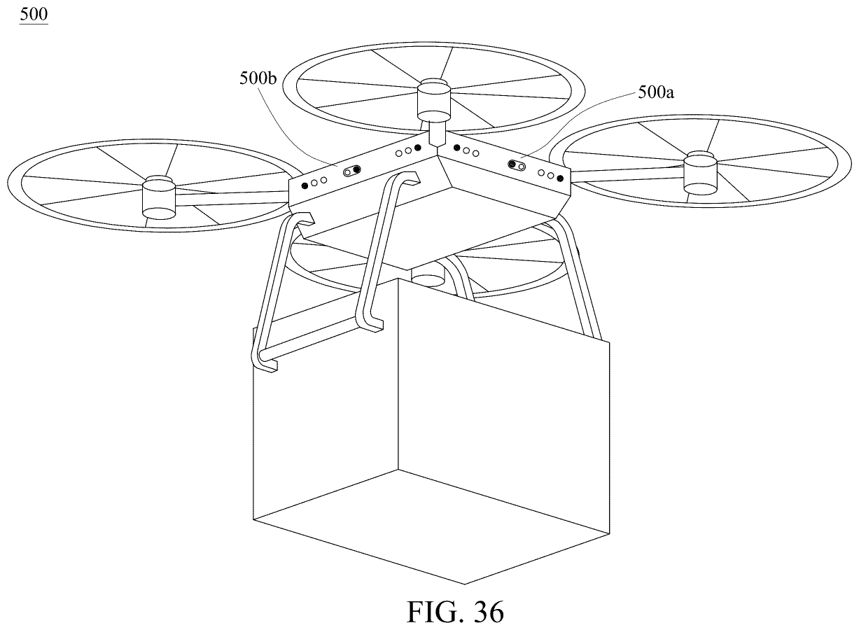

Please refer to FIG. 36, which is a perspective view of an electronic device according to the 8th embodiment of the present disclosure.

In this embodiment, the electronic device 500 is an unmanned aerial vehicle (UAV), which can, for example, be a delivery drone equipped with a storage compartment. The electronic device 500 includes a front camera module 500a and a side camera module 500b. The front camera module 500a and the side camera module 500b can each include the optical lens of the present disclosure and an image sensor disposed on an image surface of the optical lens. The front camera module 500a and the side camera module 500b provide the electronic device 500 with reliable optical imaging quality and environmental durability. The electronic device 500 is exemplified as including two camera modules 500a and 500b, but the number and arrangement of camera modules are not intended to limit the present disclosure.

The smartphones, panoramic view car cameras, dashboard cameras, vehicle backup cameras and unmanned aerial vehicles in the embodiments are only exemplary for showing the optical lens and the camera module of the present disclosure installed in an electronic device, and the present disclosure is not limited thereto. The optical lens and the camera module can be optionally applied to optical systems with a movable focus. Furthermore, the optical lens and the camera module feature good capability in aberration corrections and high image quality, and can be applied to 3D (three-dimensional) image capturing applications, in products such as digital cameras, mobile devices, digital tablets, smart televisions, network surveillance devices, multi-camera devices, image recognition systems, motion sensing input devices, wearable devices and other electronic imaging devices.

The foregoing description, for the purpose of explanation, has been described with reference to specific embodiments. It is to be noted that the present disclosure shows different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical lens having an optical axis, and the optical axis comprising:
a lens barrel, wherein the optical axis passes through the lens barrel;
a lens element arranged along the optical axis and disposed in the lens barrel, the lens element having a first region, and the first region surrounding the optical axis;
a spacer element arranged adjacent to the lens element and surrounding the optical axis, and the spacer element having:
a first surface, wherein the first region of the lens element is supported on the first surface in a direction parallel to the optical axis;
a second surface disposed opposite to the first surface;
a near-axis side surface connected to the first surface on a side closest to the optical axis and to the second surface on a side closest to the optical axis, the near-axis side surface surrounding the optical axis and gradually tapering toward the optical axis, forming a light-passing hole; and
a far-axis side surface connected to the first surface on a side farthest from the optical axis and to the second surface on a side farthest from the optical axis; and
a retaining element fixedly arranged with the lens barrel to maintain a relative fixed position between the lens element and the lens barrel along the optical axis, the spacer element disposed between the lens element and the retaining element, and the retaining element having:
a second region supported on the second surface in a direction parallel to the optical axis, and the second region surrounding the optical axis;
wherein the first region and the second region do not overlap in a direction parallel to the optical axis.

2. The optical lens of claim 1, wherein the retaining element comprises a retaining portion extending in a direction toward the optical axis, and the retaining portion has the second region.

3. The optical lens of claim 2, wherein a distance between the first region and the second region in a direction perpendicular to the optical axis is VG, and the following condition is satisfied:
0.01 mm≤VG≤1.2 mm.

4. The optical lens of claim 3, wherein the distance between the first region and the second region in the direction perpendicular to the optical axis is VG, a distance between the first region and the second region in a direction parallel to the optical axis is HG, and the following condition is satisfied:
0.03≤VG/HG≤3.1.

5. The optical lens of claim 2, wherein the retaining element further comprises a barb structure arranged spaced apart from the retaining portion, and the barb structure is located closer to the optical axis than the far-axis side surface of the spacer element; and
wherein the spacer element is disposed between the barb structure and the retaining portion.

6. The optical lens of claim 5, wherein the barb structure faces the lens element and is arranged spaced apart from the lens element, and the barb structure is located farther from the optical axis than the lens element.

7. The optical lens of claim 2, wherein a cross-section parallel to the optical axis and passing through the optical axis is defined; and
wherein in the cross-section, a length of the first region in a direction perpendicular to the optical axis is RF1, a length of the second region in a direction perpendicular to the optical axis is RF2, and the following condition is satisfied:
0.1≤RF1/RF2≤5.1.

8. The optical lens of claim 7, wherein in the cross-section, the length of the first region in the direction perpendicular to the optical axis is RF1, the length of the second region in the direction perpendicular to the optical axis is RF2, and the following condition is satisfied:
0.2≤RF1/RF2≤2.5.

9. The optical lens of claim 1, wherein the spacer element is made of plastic material.

10. The optical lens of claim 1, wherein the retaining element is made of metal material.

11. The optical lens of claim 1, further comprising a lens group, wherein the lens group comprises the lens element, and the lens group includes at least one plastic lens element and at least one glass lens element.

12. The optical lens of claim 11, wherein the lens element is made of plastic material.

13. The optical lens of claim 1, wherein the spacer element and at least one of the lens barrel and the retaining element have a clearance fit with each other in a direction perpendicular to the optical axis.

14. The optical lens of claim 13, wherein a gap is formed between the far-axis side surface and at least one of the lens barrel and the retaining element, and the gap extends from the far-axis side surface toward the optical axis along at least one of the first surface and the second surface; and
wherein the gap overlaps with at least one of the first region and the second region in a direction parallel to the optical axis.

15. The optical lens of claim 14, further comprising a damper disposed in the gap.

16. The optical lens of claim 1, further comprising a light-blocking element disposed between the lens element and the spacer element, wherein the light-blocking element surrounds the optical axis.

17. The optical lens of claim 1, further comprising a light-blocking element disposed between the spacer element and the retaining element, wherein the light-blocking element surrounds the optical axis.

18. The optical lens of claim 1, wherein the near-axis side surface of the spacer element has an anti-reflective surface, and a reflectance of the anti-reflective surface is lower than a reflectance of the far-axis side surface.

19. The optical lens of claim 2, wherein the retaining portion further has a stop surface, the spacer element further has a counterpart stop surface, the stop surface and the counterpart stop surface are disposed opposite to each other, and a distance between the counterpart stop surface and the stop surface gradually increases in a direction away from the second region; and
wherein a cross-section parallel to the optical axis and passing through the optical axis is defined, the stop surface and the counterpart stop surface form an angle A1 in the cross-section, and the following condition is satisfied:
A1≤20 degrees.

20. The optical lens of claim 19, wherein a length of the stop surface in the cross-section is SF, a length of the counterpart stop surface in the cross-section is CSF, and the following condition is satisfied:
0.4≤SF/CSF≤2.5.

21. A camera module comprising:
the optical lens of claim 1; and
an image sensor disposed on an image surface of the optical lens.

22. An electronic device comprising:
the camera module of claim 21.

23. An optical lens having an optical axis, and the optical lens comprising:
a lens barrel, wherein the optical axis passes through the lens barrel, and the lens barrel has a first annular surface surrounding the optical axis;
a lens element arranged along the optical axis and disposed on the first annular surface, the lens element having a first region, and the first region surrounding the optical axis;
a spacer element arranged adjacent to the lens element and surrounding the optical axis, and the spacer element having:
a first surface, wherein the first region of the lens element is supported on the first surface in a direction parallel to the optical axis;
a second surface disposed opposite to the first surface;
a near-axis side surface connected to the first surface on a side closest to the optical axis and to the second surface on a side closest to the optical axis, the near-axis side surface surrounding the optical axis and gradually tapering toward the optical axis, forming a light-passing hole; and
a far-axis side surface connected to the first surface on a side farthest from the optical axis and to the second surface on a side farthest from the optical axis; and
a retaining element fixedly arranged with the lens barrel to maintain a relative fixed position between the lens element and the lens barrel along the optical axis, the spacer element disposed between the lens element and the retaining element, and the retaining element having:
a second annular surface surrounding the optical axis; and
a second region supported on the second surface in a direction parallel to the optical axis, and the second region surrounding the optical axis;
wherein a gap is formed between the far-axis side surface and at least one of the first annular surface and the second annular surface, and the gap extends from the far-axis side surface toward the optical axis along at least one of the first surface and the second surface;
wherein the first annular surface and/or the second annular surface, which form the gap with the far-axis side surface, face the far-axis side surface; and
wherein the gap overlaps with one of the first region and the second region in a direction parallel to the optical axis.

24. The optical lens of claim 23, wherein the retaining element comprises a retaining portion extending in a direction toward the optical axis, and the retaining portion has the second region.

25. The optical lens of claim 24, wherein the retaining element further comprises a barb structure arranged spaced apart from the retaining portion, and the barb structure is located closer to the optical axis than the far-axis side surface of the spacer element; and
wherein the spacer element is disposed between the barb structure and the retaining portion.

26. The optical lens of claim 25, wherein the barb structure faces the lens element and is arranged spaced apart from the lens element, and the barb structure is located farther from the optical axis than the lens element.

27. The optical lens of claim 23, wherein the far-axis side surface faces the lens barrel, a distance between the far-axis side surface and the lens barrel in a direction perpendicular to the optical axis is SG, and the following condition is satisfied:
0.007 mm≤SG≤0.06 mm.

28. The optical lens of claim 27, wherein a maximum distance between the spacer element and a center of the lens element is SL, the distance between the far-axis side surface and the lens barrel in the direction perpendicular to the optical axis is SG, and the following condition is satisfied:
0.9901≤SL/(SL+SG)≤0.9999.

29. The optical lens of claim 23, wherein the far-axis side surface faces the retaining element; and
wherein a distance between the far-axis side surface and the retaining element in a direction perpendicular to the optical axis is SGD, and the following condition is satisfied:
0.007 mm≤SGD≤0.06 mm.

30. The optical lens of claim 29, wherein a maximum distance between the spacer element and a center of the lens element is SL, the distance between the far-axis side surface and the retaining element in the direction perpendicular to the optical axis is SGD, and the following condition is satisfied:
0.9901≤SL/(SL+SGD)≤0.9999.

31. The optical lens of claim 23, wherein the spacer element is made of plastic material.

32. The optical lens of claim 23, wherein the retaining element is made of metal material.

33. The optical lens of claim 23, further comprising a lens group, wherein the lens group comprises the lens element, and the lens group includes at least one plastic lens element and at least one glass lens element.

34. The optical lens of claim 33, wherein the lens element is made of plastic material.

35. The optical lens of claim 23, further comprising a damper disposed in the gap.

36. The optical lens of claim 23, further comprising a light-blocking element disposed between the lens element and the spacer element, wherein the light-blocking element surrounds the optical axis.

37. The optical lens of claim 23, further comprising a light-blocking element disposed between the spacer element and the retaining element, wherein the light-blocking element surrounds the optical axis.

38. The optical lens of claim 23, wherein the near-axis side surface of the spacer element has an anti-reflective surface, and a reflectance of the anti-reflective surface is lower than a reflectance of the far-axis side surface.

39. The optical lens of claim 24, wherein the retaining portion further has a stop surface, the spacer element further has a counterpart stop surface, the stop surface and the counterpart stop surface are disposed opposite to each other, and a distance between the counterpart stop surface and the stop surface gradually increases in a direction away from the second region; and
wherein a cross-section parallel to the optical axis and passing through the optical axis is defined, the stop surface and the counterpart stop surface form an angle A1 in the cross-section, and the following condition is satisfied:
A1≤20 degrees.

40. A camera module comprising:
the optical lens of claim 23; and
an image sensor disposed on an image surface of the optical lens.

41. An electronic device comprising:
the camera module of claim 40.
